(19) United States
(12) Patent Application Publication
(10) Pub. No.: US 2014/0304107 A1
(43) Pub. Date: Oct. 9, 2014

(54) WEBROOMING WITH RFID-SCANNING ROBOTS

(71) Applicant: Clarke William McAllister, Eugene, OR (US)

(72) Inventor: Clarke William McAllister, Eugene, OR (US)

(21) Appl. No.: 14/311,215

(22) Filed: Jun. 20, 2014

Related U.S. Application Data
(63) Continuation-in-part of application No. 13/693,026, filed on Dec. 3, 2012.
(60) Provisional application No. 61/838,186, filed on Jun. 21, 2013.
(60) Provisional application No. 61/879,054, filed on Sep. 17, 2013.
(60) Provisional application No. 61/989,823, filed on May 7, 2014.

(51) Int. Cl. G06Q 10/08; G06Q 30/06; G06K 7/10

(52) U.S. Cl. CPC G06Q 10/087; G06K 7/10366; G06Q 30/0631; G06Q 30/0641
USPC 705/26.7; 235/385

(57) ABSTRACT

The present invention relates to systems, methods, and devices for using RFID-tagged items for omnichannel shopping and automatically reading and locating those items. Robots for automated RFID reading are disclosed. The present invention discloses Webrooming 2.0 (WR2.0) which will offer shoppers new views and tools. WR2.0 offers shoppers a bird's eye view of equivalent items in local retail stores. WR2.0 tools empower shoppers with preemptive purchasing power: the ability to redirect their online purchases from any online web store to a local retail store.

### RELATED APPLICATIONS

The present application is a continuation-in-part application which claims benefit based on co-pending U.S. patent application Ser. No. 13/693,026 filed on 3 Dec. 2012, which claims benefit of co-pending U.S. patent application Ser. No. 13/526,520 filed on 19 Jun. 2012, which claims benefit of U.S. patent application Ser. No. 12/820,109 (U.S. Pat. No. 8,228,198) filed on 21 Jun. 2010, which claims benefit of U.S. patent application Ser. No. 11/465,712 (U.S. Pat. No. 7,830,258) filed on 18 Aug. 2006, and U.S. Patent Application No. 60/709,713 filed on 19 Aug. 2005, and a continuation-in-part of U.S. patent application Ser. No. 12/124,768 (abandoned) filed on 21 May 2008, which claims benefit of U.S. Provisional Patent App. No. 60/939,603 filed on 22 May 2007, all by the same inventor Clarke W. McAllister. The present application also claims the benefit under 35 USC Section 119(e) of U.S. Provisional Application Nos. 61/838,186 filed 21 Jun. 2013, and 61/879,054 filed 17 Sep. 2013, and 61/989,823 filed 7 May 2014, and 61/567,117 filed 5 Dec. 2011, and 61/677,470 filed 30 Jul. 2012, and 61/708,207 filed 1 Oct. 2012, and of 61/709,771 filed 4 Oct. 2012, all by the same inventor Clarke W. McAllister, the disclosures of which are expressly incorporated herein by reference.

### BACKGROUND

Many shoppers conduct product research online and then go to brick-and-mortar retail stores to purchase selected products. Smart phones, tablets, and computers are used for both showrooming and reverse showrooming, also know as webrooming, where one sales channel supports the other. Omnichannel sales is a seamless offering of sales channels to shoppers where retailers make sure that shoppers can mix modes of retail activities and interactions.

The present invention discloses Webrooming 2.0 (WR2.0) which will offer shoppers new views and tools. WR2.0 offers shoppers a bird's eye view of equivalent items in local retail stores. WR2.0 tools empower shoppers with preemptive purchasing power: the ability to redirect their online purchases from any online web store to a local retail store.

An omnichannel risk for retailers is to commit retail items to a shopper without accurately knowing if the item is in stock, the risk becomes a major problem if the shopper is traveling to the retail store to pick it up and it's not there. There are many examples of RFID technology being used in retail stores for inventory counting. Without using RFID to gain inventory accuracy, there is a 30% chance that a “buy online and pickup-at-store” transaction will lead to a “no stock” result when the shopper arrives to receive the purchased item. This erodes the customer relationship thus raising the total cost to the retailer.

Shoppers want what they want where and when they want it. Retail purchasing options are increasing with both vertical and horizontal shopping modes for product comparisons.

Hukkster is an e-commerce company that provides a bookmarklet for shoppers to track and mark retail products on websites and the Hukkster server notifies the shopper via text or email when that product goes on sale. Hukkster falls short of tracking that retail inventory in brick-and-mortar stores.

Amazon Firefly is a feature on the Amazon Fire Phone that can scan 100 million real world objects and match them with items for sale through Amazon.com. Firefly scans the physical world around you and helps you buy it.

Google Shopping Express is an online shopping marketplace with delivery service. This site lacks the ability to find retail items with limited inventories where accurate counts are essential such as apparel, handbags, and footwear. Radio-frequency identification (RFID) transponders enable improved identification and tracking of objects by encoding data electronically in a compact tag or label.

Radio-frequency identification (RFID) transponders, typically thin transceivers that include an integrated circuit chip having radio frequency circuits, control logic, memory and an antenna structure mounted on a supporting substrate, enable vast amounts of information to be encoded and stored and have unique identification.

RFID transponders rank into two primary categories: active (or battery assist) RFID transponders and passive RFID transponders. Active RFID transponders include an integrated power source capable of self-generating signals, which may be used by other, remote reading devices to interpret the data associated with the transponder. Active transponders include batteries and, historically, are considered considerably more expensive than passive RFID transponders. Passive RFID transponders backscatter incident RF energy to remote devices such as interrogators.

Despite recent advances in RFID technology, the state-of-the-art does not adequately address automated data collection. In high cost solutions such as the STAR 3000 from Mojix, there is generally a single vantage point and multiple tag exciters installed for reading RFID-tagged items in a retail store floor. In the present invention mobile robots utilize a plurality of vantage points that comprise a constellation, a configuration of vantage points.

In US2010/0049368 inventor Chen teaches a robot that moves in response to operating instructions from an identified human voice.

In WO 2013/071150A1 inventor Davidson discloses a three-wheeled robot for RFID-scanning retail stores and warehouses. In WO2005/076929 inventor Baker teaches a portal reader comprising a vertical column of RFID antennae. WO 2006/076283 describes an RFID cart which broadly includes a definition of cart that includes robots and a mobile component comprising at least two wheels. Inventors Davidson and Melton et al in their respective patents fail to disclose how to prevent tipping and to maintain a two-wheeled robot in an upright and operational position. Similarly inventor Zini in WO 2007/047510 mentions a two-wheeled robot, yet fails to address the challenges of balance. Zimmerman in U.S. Pat. No. 7,693,757 discloses a robot with an undisclosed number of wheels also fails to address balance. Unlike the present invention that discloses a two-wheeled robot and an aerial scanning platform, this prior art could not have enabled the present invention. This patent, the patent below, and all other prior art fail to address or solve for the blinding affects reflected carrier from reflective objects in the field of a high gain antenna.

Reflections from shelving and other metal objects in the field of an RFID reader are can blind and possibly saturate baseband amplifiers preventing tag reading. In U.S. Pat. No. 7,733,230 inventors Karen Bomber et al teach the use of a mobile platform with a repositionable antenna structure comprised of at least one readpoint antenna coupled to an antenna tower for reading tags. This patent fails to teach avoidance of retro-reflection problems, nor contemplates the need to narrow or sweep a beam to prevent data loss.

In U.S. Pat. No. 8,237,563 inventors Schatz, et al teach a fork lift reader that determines if a tag is within a small predefined zone or not. In US 2012/0112904 inventor Nagy teaches a tag location system using a plurality of receivers placed about a predefined area. In US2011/0169607 and WO2011/088182 inventor Paulson teaches a tag location system using separate exciters and wideband signals to multiple receiver antennae. In WO2011/135329 and U.S. Pat. No. 8,077,041 the inventors teach a tag location system using a plurality of antenna coupled to an RF transmitter/receiver. In WO2008/118875, US2012/0139704, and EP2137710 inventors Sadr et al teach an RFID tag system comprising a plurality of exciters. In WO2007/094868 Sadr et al teach an RFID receiver that applies predetermined probabilities to a plurality of signal pairs to extract data. In US2010/0310019 inventor Sadr teaches estimation of received signals. In U.S. Pat. No. 8,174,369 inventors Jones and Sadr teach encoding and decoding tags using code word elements. In US2012/02755464 inventor Divsalar teaches a noncoherent soft output detector. In US2011/0254664 inventors Sadr and Jones teach a sensor cloud with a plurality of read zones. In US2012/0188058 Lee and Jones teach a joint beamformer and a plurality of antennae. In US2011/0090059 inventor Sadr teaches an antenna array used to determine RFID tag locations.

RFID tags with directional gain are disclosed in WO 2009/037593 and are used as geostationary reference points that overcome multipath problems that are associated with RFID-based localization.

Yahoo was assigned U.S. Pat. No. 7,692,536 by inventor Channell who teaches the use of RFID-tagged foodstuffs that when scanned provide data to a recommendation system that recommends recipes. Another kitchen inventory RFID-scanning patent application is US 2009/0095813. These differ from the present invention that assists shoppers in the acquisition stage of RFID-tagged goods rather than the usage stage long after the items are purchased.

US patent application US 2004/0073485 teaches a method for a central server for providing a promotion to a plurality of application servers. It differs at least by failing to assure inventory availability.

US patent application US2014/0032034 for a delivery system comprising: one or more unmanned delivery vehicles configured for autonomous navigation.

U.S. Pat. No. 7,742,773 teaches a system for locating people or assets. This differs from the present invention where a mobile device locates itself. U.S. Pat. No. 6,354,493, U.S. Pat. Nos. 5,689,238, 4,636,950, U.S. Pat. No. 4,598,275, U.S. Pat. No. 4,471,345, U.S. Pat. No. 4,918,425, U.S. Pat. No. 5,785,181, U.S. Pat. No. 6,002,344, U.S. Pat. No. 5,798,693, U.S. Pat. No. 4,476,469 and U.S. Pat. No. 5,214,410 (a patent which discloses a narrow beam width antenna) disclose devices and methods for finding a specific RFID-tagged article, item, document, or person located among a plurality of such but all fail to anticipate or teach recording the locations of the plurality of tags into a high resolution representation of a three-dimensional space.

U.S. Pat. No. 5,963,134 and U.S. Pat. No. 6,195,006 disclose a library book tracking system with location tracking to zones of a library, falling short of teaching how to record locations of items in their three-dimensional storage space.

U.S. Pat. No. 5,708,423 does disclose a method for tracking the locations of tagged objects as the objects pass through doorways. When applied to the problem of counting and locating retail store inventory, would merely indicate that an item is on the retail sales floor or in the stock room, which is insufficient localization.

U.S. Pat. No. 7,821,391 discloses a GPS tracking system for RFID-tagged objects. However the inventors fail to teach how to track without dependence on GPS; retail stores generally being GPS-denied environments.

US patent application 2008/0106377 discloses a mobile inventory tracking device and system for RFID-tagged items that are stored in a cellular arrangement of racks. Inventors Flores et al fail to disclose the preferred frequency band, preferred embodiment of RFID tags, preferred racking material, or dimension limits of the cells. Those skilled in the art would know that achieving location resolutions that are on the order of two wavelengths or less require close attention to the omitted details; for example a 915 MHz system: resolutions less than two feet. This falls short of the present invention that takes these points and carrier wave reflections into account. The same shortcoming is also true of U.S. Pat. No. 7,916,028 for failing to account for carrier wave properties.

In U.S. Pat. No. 7,119,738, U.S. Pat. No. 6,414,626, and U.S. Pat. No. 6,122,329 the inventors teach methods of comparing phase and frequency to compute the reader to tag distance and with three readers computing RFID tag location. U.S. Pat. No. 7,319,397 teaches a RFID tag location system using a plurality of relay devices. WO 2008097509 similarly teaches a plurality of multiplexed antennae. The present invention differs by using just one RFID reader and several vantage points to determine tag location in three-dimensional space.

US patent application 2012/0293373 teaches an RTLS system using a plurality of receivers. U.S. Pat. No. 8,754,752 and U.S. Pat. No. 8,294,554 use three RFID readers in three different locations that work cooperatively to listen to responses from interrogated RFID tags to determine their locations. Inventors Shoarinejad et al fail to anticipate the need for or teach using a single RFID reader to perform the tag location function.

RFID Journal subscribers' article “World Wildlife Fund Uses RFID to Foil Poachers” published 13 Apr. 2014 reviews a system for tracking endangered rhinos using RFID and UAV's in Namibia. Interesting as it is, it fails to teach how to find and locate retail items in a retail store.

No prior art comprehensively teaches systems, methods or devices for avoiding carrier reflections and automatically determining the presence and location of retail store inventory. Nor does the prior art teach how to access that inventory location information in a useful manner for shoppers, thus to enable Webrooming 2.0 manner of shopping.

### SUMMARY OF THE INVENTION

The present invention teaches how consumers automatically gain visibility to the presence and locations of RFID-tagged items for omnichannel shopping. This invention overcomes the shortcomings of four core elements to achieve the above stated purpose. The core elements are: RFID scanning, robots, indoor navigation, and cross-channel product searching.

### RFID Scanning

The major problem with prior art RFID scanning is that blinding reflections of the reader's carrier wave from nearby metal objects causes momentary lapses in the reader's scanning operation. The preferred solution is to narrow and methodically change the incident angle of the carrier wave to read each tag from multiple vantage points. Vantage points are selected to afford a variety of carrier wave incidence angles to achieve the highest possible read rate and intersecting vectors to compute the three dimensional location of each RFID tag and its associated item. The present invention utilizes a plurality of vantage points that comprise a constellation, a configuration of vantage points.

### Robots

The present invention discloses data collection using scanning systems, including, rolling robots, aerial robots which are also known as micro aerial vehicles (MAV's), that automatically scan RFID-tagged goods to detect the presence and location of the tagged retail items within brick-and-mortar retail stores. In order to accurately determine the location and availability of products inventories of goods are preferably scanned from two or more vantage points.

Preferred micro aerial vehicles include tricopters, quadcopters, hexacopters, and octocopters. The Iris quadcopter, built by 3D Robotics and the DJI Phantom 2 are preferred embodiments of quadcopters for MAV-based RFID scanning.

Preferred MAV autopilot capabilities include all flight controls that are required for stable autonomous flight and control of X, Y, Z translation, and rotation in the pitch, roll, and yaw axes. Preferred embodiments of the present invention include a channel for reporting MAV position and attitude to a data collection module at regular intervals.

The data collection module preferably collects records of RFID tags that have been read and associates their time of reading with the current position and attitude of the RFID antenna that read it.

### Indoor Navigation

A challenge with indoor navigation is the sensing of reference points. Radio signals from references that are external to the retail store, such as GPS are often too weak to penetrate store walls and ceilings, especially if there are layers of carbon or metal in the building materials. Indoor navigation solutions that are common in industrial facilities such as factories and warehouses are aesthetically or functionally inappropriate for many retail stores. Scene-based optical navigation requires lighting that may not be present during a lights-out scan of a retail store or warehouse. The present invention overcomes those shortcomings by using indoor navigation means that include acoustic signal sensing, sensing optical references, and using radio signal references.

### Cross-Channel Product Searching

Google Shopping Express, Hukkster, TheFind, BuyVia and other websites are a few of the many examples of cross-channel web-based search tools for shoppers. Google Goggles and Pounce are smartphone apps that enable a smartphone camera to provide search criteria in a visual form. The shortcomings of them all are the lack of visibility to actual retail store inventory. Their searches are in the virtual world, but due to inherent inventory inaccuracy, there is a gap between that and the actual physical world.

Preferred embodiments of the present invention determine the consumer's present focus of product interest using opportunistic media content using traditional media devices including radio, TV, or web browsers to view online shopping sites. Application programs preferably activated by a consumer on their computing or mobile device enable identification of the consumer's immediate product interest. For web browsers, consumers preferably use a bookmark applet or bookmarklet to identify their product purchase interests. For moments when a consumer is captivated by a radio or TV presentation of certain products an application program enables identification of the product.

Common to these forms of identifying a consumer's interest in a product is a subsequent step of presenting filtered product availability information and an action such as a button or hyperlink for process steps that preferably include product purchasing. The filter preferably creates product purchase recommendations using a triple constraint triangle that reflects the consumer's expressed preferences for quality, price, and delivery speed.

### DRAWINGS

FIG. 1 is a top side angle view of an RFID tag reading robot according to one embodiment of the present invention.

FIG. 2 is a top view of a cable driven aerial mobile RFID reader according to one embodiment of the present invention.

FIG. 3 is a tethered top side angle view of an aerial mobile RFID reader system according to one embodiment of the present invention.

FIG. 4 is an RFID tag reading micro air vehicle according to one embodiment of the present invention.

FIG. 5 is a quadix antenna-equipped RFID tag reading micro air vehicle according to one embodiment of the present invention.

FIG. 6 is a system block diagram of an RFID tag reading MAV according to one embodiment of the present invention.

FIG. 7 is an oblique view of a crash-resistant propeller for an aerial robot according to one embodiment of the present invention.

FIG. 8 is an overhead optical location reference strip according to one embodiment of the present invention.

FIG. 9 is a directional RFID tag for indication of a location according to one embodiment of the present invention.

FIG. 10 is a vectored arrangement of directional RFID tags according to one embodiment of the present invention.

FIG. 11 is a tag discovery diagram for robotically controlled azimuth and elevation angles according to one embodiment of the present invention.

FIG. 12 is a diagram of Prior Art showing retro-reflected carrier signals while reading a plurality of RFID tags.

FIG. 13 is a diagram according to one embodiment of the present invention for overcoming carrier reflections to read a plurality of RFID tags.

FIG. 14 is a top view of an aerial robot flight scan pattern within a retail store according to one embodiment of the present invention.

FIG. 15 is a diagrammatic representation of a map superimposed onto a top view of a sales floor according to one embodiment of the present invention.

FIG. 16 is a diagram of a product recommendation system according to one embodiment of the present invention.

### DESCRIPTION OF THE INVENTION

Shoppers can use a Webrooming 2.0 (WR2.0) bookmarklet on a retail website to see availability of equivalent items at local stores. Radio frequency identification (RFID) tags on retail items assures fast and accurate daily automatic counting of brick-and-mortar store inventories. This allows retailers to use their stores as warehouses for online shoppers. A WR2.0 bookmarklet “BUY” button/icon optionally serve as a front end to a retailer's buy online pickup at store (BOPS) program. Preferred WR2.0 system embodiments integrate with RFID systems used by early adopters such as Macy's, Walmart, and JC Penney.

Making reference to various figures of the drawings, possible embodiments of the present invention are described and those skilled in the art will understand that alternative configurations and combinations of components may be substituted without subtracting from the invention. Also, in some figures certain components are omitted to more clearly illustrate the invention, similar features share common reference numbers.

To clarify certain aspects of the present invention, certain embodiments are described in a possible environment—as identification means for retail items that are bought and used by shoppers or consumers. In these instances, certain methods make reference to items such as clothing, garments, shoes, handbags, consumables, electronics, and tires, but other items may be used by these methods. Certain embodiments of the present invention are directed for identifying objects using RFID transponders in supply chains and retail stores.

Some terms are used interchangeably as a convenience and, accordingly, are not intended as a limitation. For example, transponder is a term for wireless sensors that is often used interchangeably with the term tags and the term inlay, which is used interchangeably with inlet. This document generally uses the term tag or RF tag to refer to passive inlay transponders, which do not include a battery, but include an antenna structure coupled to an RFID chip to form an inlay which is generally thin and flat and substantially co-planar and may be constructed on top of a layer of foam standoff, a dielectric material, or a folded substrate. One common type of passive inlay transponder further includes a pressure-sensitive adhesive backing positioned opposite an inlay carrier layer. Chipless RFID transponders are manufactured using polymers instead of silicon for cost reduction. Graphene tags offer similar benefits.

Inlays are frequently embedded in hang tags, pocket flashers, product packaging, and smart labels. A third type: a battery-assist tag is a hybrid RFID transponder that uses a battery to power the RFID chip and a backscatter return link to the interrogator.

The systems, methods, and devices of the present invention utilize RFID tag or transponder means that respond to RFID interrogation signals from an antenna according to a preferred frequency, modulation type, and protocol as disclosed below. The transponders are responsive to RFID tag reading means for reading a unique item identifier from each of a plurality of RFID tags. Preferred RFID tag reading means include RFID interrogator chips such as the AS3992 or AS3993 UHF RFID Reader IC from austriamicrosystems AG. Other preferred embodiments use the PR9000 from Phychips of Korea. Embodiments for MAV 40 where RFID tags must be read at a very high rate of speed would preferably use an interrogator such as the Thingmagic M6e Micro. Each of these interrogator embodiments have one or more antenna ports connected to one or more antennae for coupling across an air interface to RFID transponders.

Certain RFID transponders and wireless sensors operate at Low Frequencies (LF), High Frequencies (HF), Ultra High Frequencies (UHF), and microwave frequencies. HF is the band of the electromagnetic spectrum that is centered around 13.56 MHz. UHF for RFID applications spans globally from about 860 MHz to 960 MHz. Transponders and tags responsive to these frequency bands generally have some form of antenna. For LF or HF there is typically an inductive loop. For UHF there is often an inductive element and one or more dipoles or a microstrip patch or other microstrip elements in their antenna structure.

Such RFID transponders and wireless sensors utilize any range of possible modulation schemes including: amplitude modulation, amplitude shift keying (ASK), double-sideband ASK, phase-shift keying, phase-reversal ASK, frequency-shift keying (FSK), phase jitter modulation, time-division multiplexing (TDM), or Ultra Wide Band (UWB) method of transmitting radio pulses across a very wide spectrum of frequencies spanning several gigahertz of bandwidth. Modulation techniques may also include the use of Orthogonal Frequency Division Multiplexing (OFDM) to derive superior data encoding and data recovery from low power radio signals. OFDM and UWB provide a robust radio link in RF noisy or multi-path environments and improved performance through and around RF absorbing or reflecting materials compared to narrowband, spread spectrum, or frequency-hopping radio systems. Wireless sensors are reused according to certain methods disclosed herein. UWB wireless sensors may be combined with narrowband, spread spectrum, or frequency-hopping inlays or wireless sensors. Preferred embodiments of the present invention use standards that are defined in EPC Radio-Frequency Identity Protocols Generation-2 Specification for Air Interface Protocol for Communications at 860-960 MHz Version 2.0.0, EPC Tag Data Standard GS1 Standard Version 1.8, and the GS1 General Specifications Version 14 which are all incorporated by reference herein.

RFID tags are preferably encoded with a GS1 Serialized Global Trade Item Number (SGTIN). A preferred method of assuring the required numerical uniqueness over a very large global population of RFID tags is to use a limited number of most significant bits to pre-allocate blocks of serial numbers to certain encoding facilities, service bureaus, or encoding methods including chip-based serialization. Chip-based serialization offers a high probability of uniqueness over a smaller population of same-GTIN encoded RFID tags than other methods. This is because any GTIN is a subset of the total population of GTINs encoded into RFID tags from the chip supplier from which the chip-based serial number is mapped into a 35-bit serial number field that is pre-allocated to a chip manufacturer using the industry-wide Multi-vendor Chip-based Serialization (MCS) scheme and U.S. Pat. No. 8,228,198.

### RFID Scanning

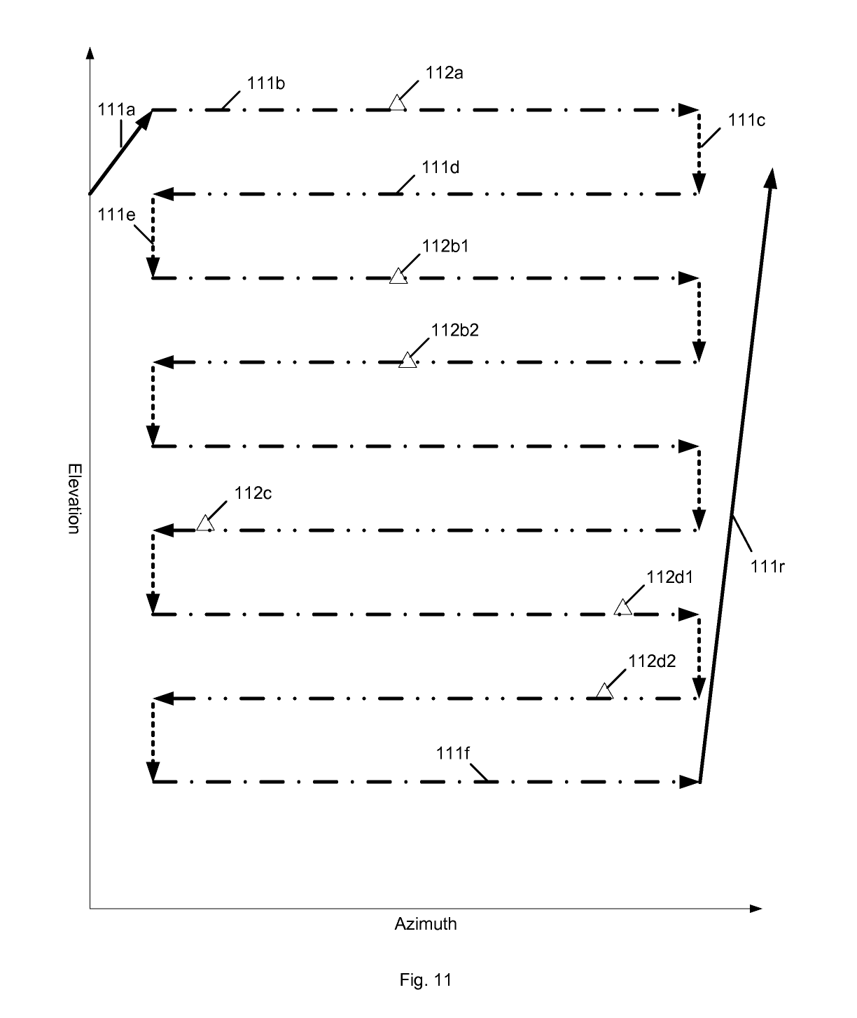

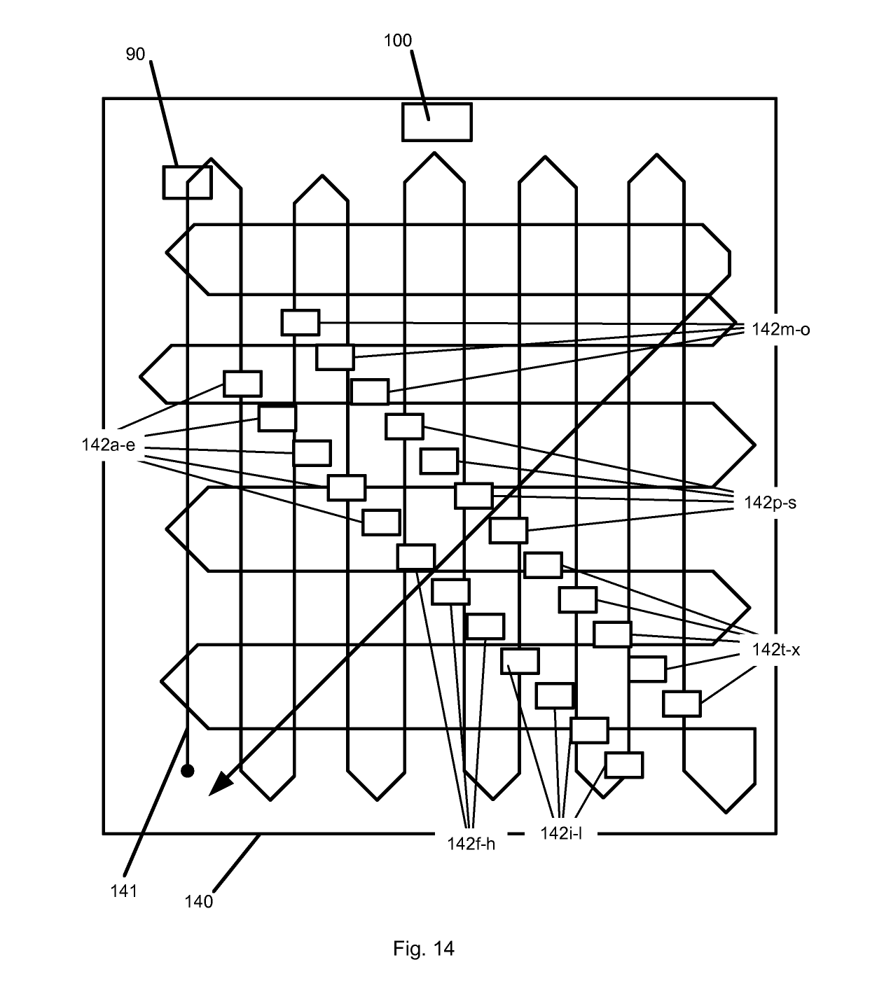

The present invention teaches systems, methods, and devices for automatic and methodical reading of item-level RFID-tagged inventory without the use of direct human labor. Automation, methodical scan patterns, and repetitive motion are compatible with and well suited to robots, not to humans. FIGS. 11, 13, and 14 illustrate preferred scan patterns that overcome prior art problems with blinding carrier wave reflections. FIG. 13 shows that the carrier wave is narrow and the central axis of the primary lobe of the field pattern from the antenna is pointed in angles that preferably result in vantage points having intersections with each other from various positions in a preferred scan pattern. The present invention teaches positioning means for autonomous positioning of the antenna in a scan pattern. There are two benefits to this type of scanning through multiple vantage points with time-variant intersecting vectors: overcoming receiver-blinding reflections and data for computation of RFID tag locations in three-dimensional space. A vantage point is a position and antenna read vector that is selected for reading RFID tags from.

For a robot at a single vantage point at a time, a narrow beam radio antenna apparatus is used for reading radio frequency identification transponders that are associated with retail product items in a retail store. The vantage point being one of a plurality of vantage points that are each in the vicinity of and provide a good view of RFID-tagged retail store items.

Vantage point selection preferably provides a constellation of read positions and read vector angles that are used by an algorithm to convert local constellations of vantage point readings into Cartesian coordinates. Preferred constellations follow a methodical scan pattern comprising a sequence of vantage points along a line or arc, or a plurality of connected lines and arcs.

Referring now to FIG. 11 is a tag discovery diagram for various azimuth and elevation angles as a robot 10, 224, 350, or 40 scans from a fixed point on or above a sales floor according to one embodiment of the present invention. A preferred scan begins as antenna 13a, 224, 350, 45, or 50 is positioned to a starting point in a rack of clothes for example by using starting move 111a. Azimuth sweep 111b encounters tag 112a before reaching its endpoint and changing elevation with move 111c to then begin return sweep 111d, and then elevation move 111e. The subsequent sweeps encounter tag read 112b1 and 112b2 of the same tag on a return sweep. Later tag reads 112c, 112d1, and 112d2 occur before final sweep 111f and robot positioning move 111r.

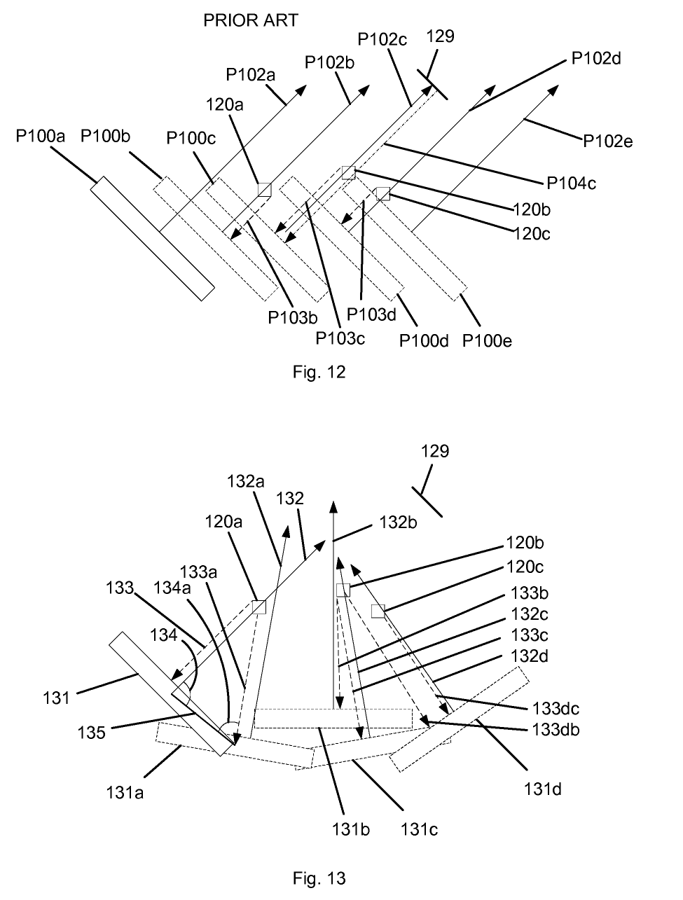

Referring to prior art in FIG. 12, inherent problems are illustrated to show how reflected carrier P102c, either modulated or un-modulated is reflected back from metal object 129 into the RFID reader's receiver. Retro-reflection path P104c to the narrow beam antenna at position P100c causes the receiver to be swamped with signal that is much greater than the back-scattered signal P103c from at least RFID transponder 120b. The result is that unless transponders 120a-c are read from a different, non-blinding angle, transponders 120b will not be recognized by the reader. Positions P100a,b,d, e are shown not to cause reflected carrier. Carriers P102a,e do not result in any tag reads. Carrier P102b results in back-scattered P103b and a successful read from transponder 120a. Carrier P102d results in back-scattered P103d and a successful read of transponder 120c, but there is in this case no successful read of transponder 120b. This problem with prior art becomes worse in warehouses and retail environments where metal racking and displays cause reflections that blind some tag reads. Prior art fails to systematically overcome this problem, failing to deliver required inventory accuracy.

Referring now to FIG. 13 is a diagram according to one embodiment of the present invention showing moving parts including antenna 131 on a mobile device that precisely directs an interrogation field to selected vectors that as an aggregate prevent missing any transponders from among the plurality of transponders 120a-c. The aggregate reads from selected vectors 132 and 132a-d prevent missing transponders for lack of illumination or from carrier reflections from object 129 by systematically changing the angle and position of antenna 131 through subsequent selected vectors that are normal to antenna positions 131 and 131a-d. Carrier 132d illuminates tag 120b and 120c resulting in backscattered responses 133db and 132dc respectively. Carrier 132 illuminates transponder 120a and through modulated protocol causes it to back-scatter response 133 to antenna 131 and its connected RFID reader for a successful read. Similarly from position 131a carrier 132a causes response 133a from transponder 120a resulting in a second read. This second read is then preferably used to triangulate the three-dimensional location of transponder 120a using the intersection point of the vectors formed by the three-dimensional angles of carrier 132 and 132a.

Preferred tag locating means for determining the location of the RFID tags relative to the reference points include triangulation computations and other geometric computations. The computations combine platform position locations, platform attitude, and antenna angle relative to the either the platform or the reference points.

Triangulation for computing the location of transponder 120a in FIG. 13 uses base line 135 that runs between the midpoints of antenna at the x,y,z position 131 and the x,y,z of position 131a. Angle 134 and angle 134a are the known pointing angles of the narrow beam antenna at points 131 and 131a respectively. The length of a perpendicular line from base line 135 to the location of the center of transponder 120a is computed using the law of sines as the length of line 135 times the sine of angle 134 times the sine of angle 134a, all divided by the sine of the sum of angles 134 and 134a. Then using the known locations of robot 10, 40, 224, or 350 at antenna positions 131 and 131a, the length of this perpendicular is then preferably converted into a store-level coordinate system such as Cartesian coordinates with an x,y,z ordered triplet of axes to record the location of transponder 120a or if the tag is a location transponder that contains coordinates, then the location of the robot is calculated and updated. Robot 10, 40, 224, and 350 preferably use accelerometers and gyros to sense motion, acceleration, and attitude.

The above calculations are based on the use of a narrow beam, high gain antenna directed along selected vectors in order for the triangulation computations to be valid and accurate. In preferred embodiments, the antenna gain has a minimum of about 11 dBic in order to form a narrow interrogation field from an RFID interrogator coupled with the antenna, for reading tags in a narrow sector of RFID-tagged inventory items at any one time. This narrowly focused beam reduces the probability that a scan will be blinded by un-modulated carrier being reflected into the receiver or for off-axis transponders to confound location by being illuminated and responsive to the carrier beam. Preferred embodiments detect amplifier saturation from blinding reflections and record the beam vector and location of blinding carrier reflections. Future scans preferably avoid known vector angles and positions that result in blinding by slightly deviating antenna angles and positions from the problem areas.

Lacking a narrow beam antenna, prior art RFID tag reading methods fail to make efficient use of the EPC-defined inventoried state of tags that enter the read field off-axis, since that off-axis distance can be large relative to the read range. Determining the location of the tags with minimal error requires that the field be swept across the transponders from more than one direction, preferably from multiple directions. Since the EPC protocol provides for inventoried tags to become silent, they will not be read again in that inventory round. In most cases the tag will not be inventoried at the center of the carrier beam, but more likely at some point somewhere between the 3 dB beam edges. This introduces angular error, with greater angular error for wide beams that emerge from low gain antennae. Inventory rounds are preferably swept across the tag from multiple angles, preferably using a high gain antenna in order to reduce the magnitude of location error.

In another embodiment the antenna means is an array of antenna elements, each element receiving backscattered signal from transponders. The angle of arrival is determined by measuring the Time Difference of Arrival (TDOA) at individual elements of the array. By measuring the difference in received phase at each element in the antenna array the direction of the transponder is determined and used as an offset angle from the normal vector from the antenna means when computing tag location from a plurality of vantage points.

Another cause for tags to not read is for a tag to be located at a null in the carrier field. A solution to this problem is to scan again from a different angle, as prescribed above for reducing location errors.

Wide interrogation beams are susceptible to more retro-reflections. For example a metal reflective object may be located at an angle of 50 degrees off of the primary axis of the central lobe of an antenna field pattern that has 6 dB of off-axis attenuation, but a reflected carrier wave returns from that metal object to the RFID reader receiver stage at a signal level that may be 80 dB greater than the signal level of the weakest backscattered RFID tag signals. The present invention teaches the use of narrow radio beams directed at various scan angles into a plurality of transponders.

Intermediate transponder location data preferably comprises transponder observations that are used for triangulation computations. Scan results are preferably reported in stages, the second stage comprising: SGTIN; observation point (i.e. location of robot x,y,z); viewing angle (elevation and azimuth); and RF power level (db). Each stage is stored and processed to produce a computation of each tag's location using a descriptor comprising: SGTIN; and computed X, Y, Z Cartesian location. The processing comprises the steps of:
1) Match all first stage SGTIN observations and consolidate the detection records
2) Match any second stage observations to the consolidated first stage records
3) Combine the first and second stage records by formulating the three-dimensional vector for both stages and compute the Cartesian point of intersection.
4) Match the result to any previous result of computed X, Y, Z location in a third stage. If there are no matches, then store as final stage transponder location data.

### Robots

In the present invention, robots are optimized for use as a platform for moving one or more RFID antennae into a sequence of positions and carrier wave vector directions that overcome prior art problems.

The present invention discloses scanning means for automatically scanning retail store inventories for the presence and location of RFID tags. Preferred platforms include rolling, tethered, suspended, and flying robotic platforms that are optimized for automated RFID scanning.

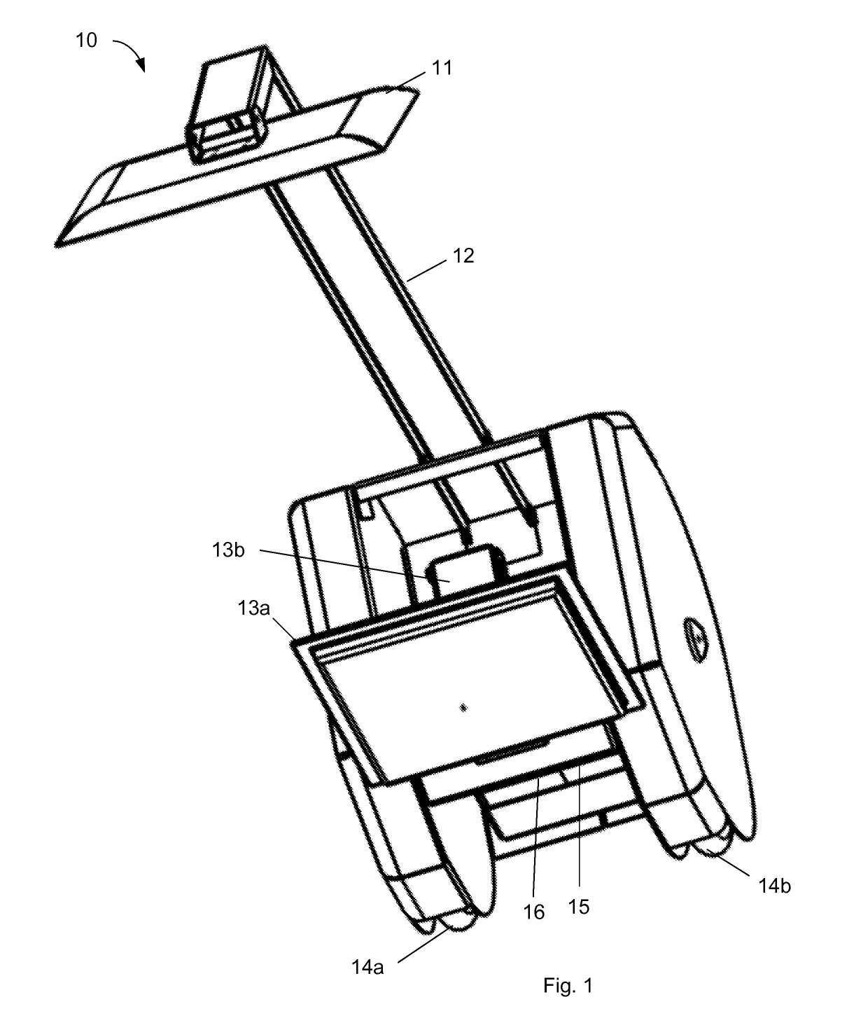

FIG. 1 shows a robot 10 in a top side-angled view. Robot 10 is preferably fabricated from folded sheet metal parts. The folded sheet metal parts preferably include the wheel wells, chassis, battery tray, antenna bracket, antenna mount, and in preferred embodiments reflector 11 and reflector mast 12. Antenna 13a is preferably a narrow beam radio antenna that preferably rotates about an axis near its bottom edge, preferably on ball bearings. Antenna controller 13b is preferably mounted in a counter balance configuration as shown so as to reduce motor torque requirements for producing a scanning motion.

Antenna controller 13b is preferably comprised of at least a gear motor, a DC motor controller, an RFID interrogator, a microelectromechanical (MEMS) accelerometer to measure pitch angle, and a pitch control loop that is stabilized by the MEMS accelerometer. Preferred embodiments use the gear motor as a winch to reel in a cable or filament to alter the angle of antenna 13a. The accelerometer is preferably used to measure the angle of antenna 13a relative to the earth's gravitational field. This is preferably used in antenna pointing computations to determine antenna pitch and to assure that antenna 13a is pointing toward reflector 11 for high scanning angles.

Robot 10 preferably includes a high-resolution color display and audio outputs to support a sales process with consumers that approach robot 10 on a retail store sales floor. In a preferred embodiment, images are projected onto a lightweight projection screen (not shown) such as a translucent plastic. Using a low cost, low power projector such as a projector manufactured from Texas Instruments DLP micro-mirror array technology, as reverse image is projected onto the backside of a translucent sheet of plastic. A consumer then preferably views the images from the front side of the plastic sheet which is preferably oriented in a direction that is primary determined by ergonomic and user interface requirements.

Using reflector 11 in conjunction with antenna 13a pointed in an upward direction overcomes a significant problem in retail stores where shelving, fixtures, and merchandise reflect or absorb RFID interrogation signals. Moving robot 10, reflector 11, and antenna 13a in a methodical manner is an improvement over prior art where store employees do not always provide a consistent reading of store inventory. Reflective surfaces of reflector 11 redirects interrogation signals from antenna 13a such that materials such as shelving and radio absorbent clothing are bypassed so that there is sufficient power reaching transponders and returning along the same signal path to an RFID reader with sufficient amplitudes for reading the transponders.

Reflector 11 and antenna 13a comprise a combined RF scanning system with variable pitch angle. The combination of antenna 13a and reflector 11 preferable comprise a narrow radio beam-shaping antenna and reflector apparatus. The narrow beam antenna apparatus offers improved transponder location detection capabilities compared to a wide beam antenna apparatus.

In preferred embodiments reflector 11 also has a motor-controlled pitch angle. In a preferred embodiment, pitch angle controller 13b uses a microelectromechanical systems (MEMS) accelerometer as an input to its control loop. A three-axis MEMS accelerometer such as an MMA8451Q from Freescale is comprised of micromachined silicon. The earth's gravitational field is sensed by the three-axis accelerometer, offering a reference for straight up vertical. In other embodiments the driving motor for varying the pitch of reflector 11 is located near the center of gravity of robot 10 with a mechanical coupling to reflector 11, which in preferred embodiments is a low friction throttle cable or other mechanical linkage.

Reflector 11 is a reflective surface that is used in certain preferred embodiments. Under FCC rules a passive reflector is considered as part of the antenna assembly of the Part 15 transmitter. At sufficient distances, the passive reflector is allowed so long as it does not increase the overall antenna gain and serves the primary purpose of overcoming obstacles that are in the path of a microwave beam. Accordingly, reflector 11 and antenna 13a preferably together form an offset-feed parabolic antenna, the shape of which is an asymmetrical segment of a paraboloid or a near paraboloid shape. Since the gain of a 0.5 meter diameter parabolic antenna for 915 MHz is 11.6 dBi, it is necessary to reduce the gain in order to comply with FCC regulations. In this preferred embodiment, gain primarily varies with the angle of antenna 13a.

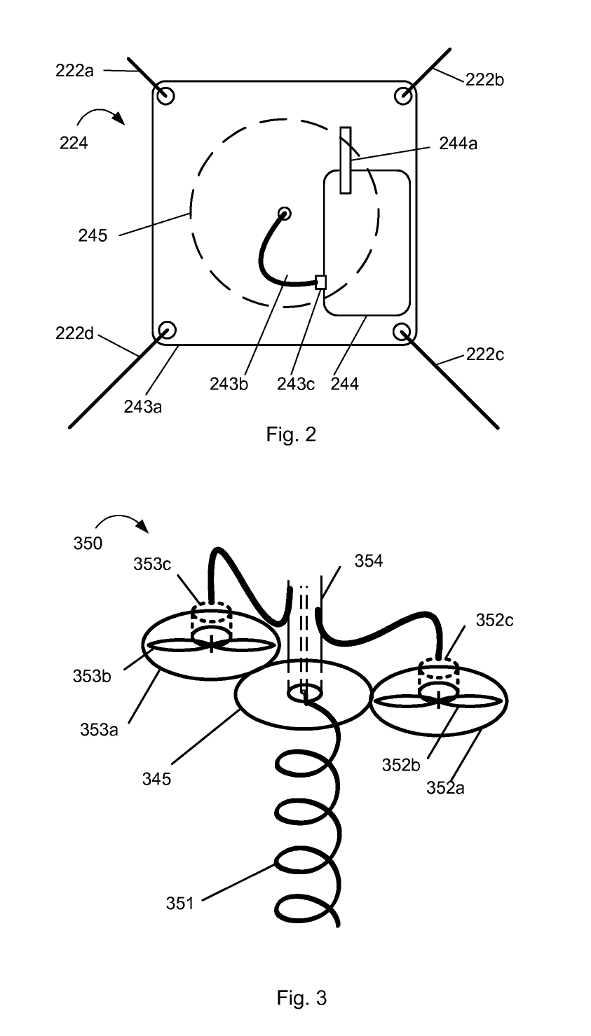

FIG. 2 shows robot 10 from a front view offering a clear view of battery pack 15 that preferably contains two 12 volt lead acid batteries. The low cost and large mass of the batteries are preferred options over more expensive battery technologies. Large mass offers a low center of gravity when the batteries are located under the axles of the wheels.

Robot controller 16 is preferably housed in an enclosure that provides EMI and moisture barrier protections. Cable lengths to sonars and hub motor wheels 14a and 14b are preferably short.

Wheels 14a and 14b are preferably comprised of e-bike hub motors that are typically produced in very high volumes, thus minimizing manufacturing costs. Preferred embodiments of wheels 14a,b use a 3-phase DC hub motor. Phase transitions are preferably controlled for both wheels in order to maintain match velocities between the two. Phase commutations are also preferably controlled by hall effect sensors that are mounted within the hub motor of wheels 14a,b. Phase currents are preferably monitored and controlled using pulse width modulation using an H-bridge driver for each of the three motor phases. Hub motors configured as either delta or wye-winding configurations are preferably supported.

Robot controller 16 is preferably comprised of one or more microcontrollers, processors, or single board computer modules having one or more processor cores, RAM, non-volatile memory (including for some embodiments a solid state disk). Robot controller 16 is also preferably comprised of one or more motor drivers such as Texas Instruments DRV8332 three phase PWM motor drivers, and sensor chips including a three-axis accelerometer such as an MMA8451Q from Freescale with 14-bit resolution, a three-axis gyroscope such as an L3GD20 from ST Micro for measuring angular rate motion, and a digital compass such as a MAG3110 digital magnetometer from Freescale. These sensors preferably detect changes in position, acceleration, and angular orientation. Controller 16 preferably detects and responds to changes in orientation under the control of algorithms that take into account the duration of the disturbance and historically related information. Controller 16 preferably learns by recording previous encounters with obstacles at certain locations, and reuses successful maneuvers to escape from known obstacles.

FIG. 3 is a preferred embodiment of a robot suspended from the ceiling of a retail store comprised of an RFID antenna 350 and propulsion for redirecting antenna 350 with reflector 345 and helical 351 in a preferred direction from its tether cable 354. Tether cable 354 conducts power and communications to a base unit. a sufficient length and propellers 352b and 353b are rotating at a sufficient angular velocity, then antenna 350 will point in a direction that is offset from a vertical axis. As angular velocity of propellers 352b and 353b increase equally and tension in cable 354 increases as an opposing force, then antenna 350 will be directed to an angle with a significant horizontal component that is sufficient for scanning a vertically aligned collection of RFID tagged items such as those arranged on a shelf in a retail store. A slight difference in angular velocity of propellers 352b and 353b will result in a lateral redirection of antenna 350 around the center of mounting plate 243a. The more massive part of antenna 350 with propellers 352b and 353b, propeller frames 352a and 353a, and motors 352c and 353c will be drawn by gravity to be below the center point of ground plane 245.

The length of tether cable 354 is preferably varied by a servo-controlled winch (not shown); varying the length of tether cable 354 and the individual velocities of propellers 352b and 353b provide complete freedom for controlled scanning of tagged items located throughout a room such as a retail store with a high gain antenna that provides a high degree of transponder location resolution. The tether location and deflection angles, deployed cable length, are used to compute transponder locations.

In other preferred embodiments the number of and arrangement of propellers is varied. In another such embodiment, one or more of propellers 352b and 353b are coaxially aligned with helical antenna 351. Propulsion and helical antenna are preferably enclosed within a protective plastic cylinder that is open at both ends whereby allowing air to flow through the tube. Direction of air and radio waves results in a highly directional RFID tag reading system.

In another preferred embodiment, flexible or rigid tether cable 354 is suspended from a dual or single mast 255a that extends above robot 250.

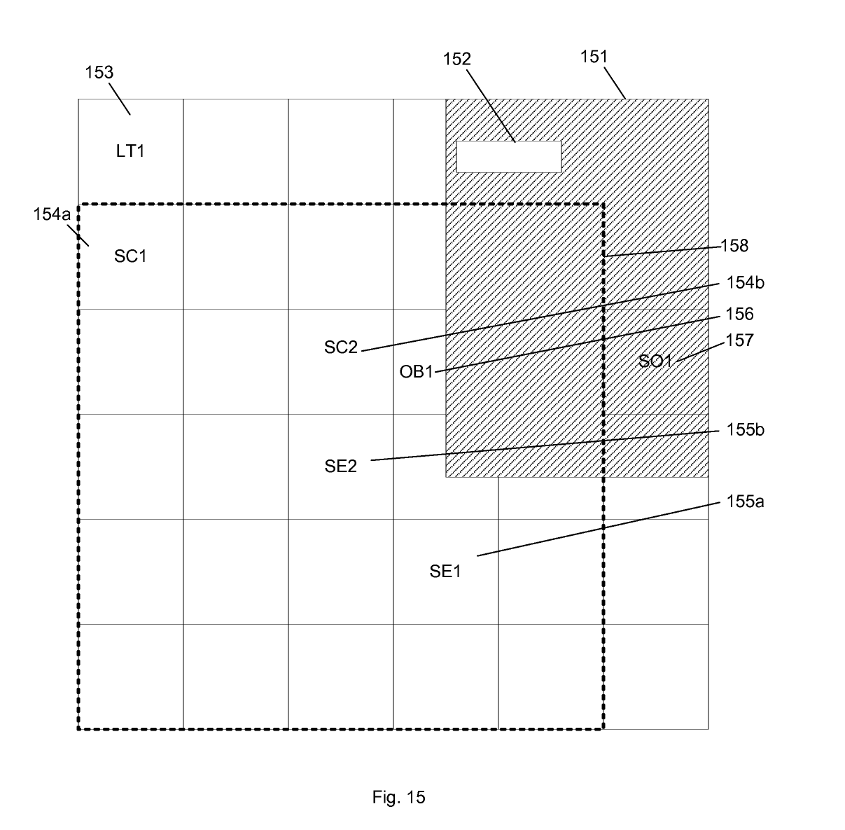

Referring now to FIG. 14 a top view of RFID reader 224 is shown with antenna ground plane 245 on the bottom side as depicted by the dotted lines in mounting plate 243a having cable attachment points at each of the four corners for suspension cables 222a,b,c,d, controlled by servo winches to create proper tension in those cable and positioning for controlled aerial mobility of aerial RFID-tag reading robot 224 at precise altitudes above the sales floor. Coax cable 243b mates with RFID to Wi-Fi bridge 244 through connector 243c. Antenna 244a provides signal gain for the wireless connection from RFID to Wi-Fi bridge 244 to access point 126 in FIG. 33.

In preferred embodiments that use propellers 352b and 353b and a length of cable 354 RFID to Wi-Fi bridge 244 is collocated with antenna ground plane 245 and part of the antenna 350 structure that “flies” under mounting plate 243a. Considerations are mass, cable flexibility, and preferred RFID scan angles. This preferred embodiment offers a higher degree of X, Y, Z, rho, theta, phi freedom of motion of antenna 350.

In other preferred embodiments, a Micro Air Vehicle (MAV) or unmanned aerial vehicle (UAV) is used as a mobile platform for moving an RFID antenna through a sequence of flight pattern positions and antenna vector angles. In a preferred embodiment for reading RFID tags in an office, warehouse, or retail space is to use UAV such as an indoor helicopter to achieve complete X, Y, Z, rho, theta, phi freedom of aerial mobility. There are several amateur UAV/MAV designs that are used by radio controlled hobbyists including quadracopters, tri-copters, hexacopters, helicopters, and many others that are preferably adapted to carrying an RFID reader for interrogation of RFID transponders. Certain preferred embodiments scan retail stores very fast achieving controlled movement of the platform at velocities in excess of 6 feet per second Another embodiment where speed is not important, a blimp or balloon is used to transport an RFID reader, antenna, and wireless telemetry. Preferred embodiments use an autopilot system such as system 60 with motors, propellers, sensors, magnetometers, gyros, and accelerometers to control the flight of RFID-reading blimp through scans of tagged inventory.

In an alternative embodiment, a steerable phased array antenna is used to sweep radio energy in elevation and azimuth, having the advantage of sweeping a beam without using moving mechanical parts. This provides advantages of multiple view points of a tag population and increasing the probability of reading all tags within the target population despite some views having high levels of carrier reflection back into the receiver of the RFID reader.

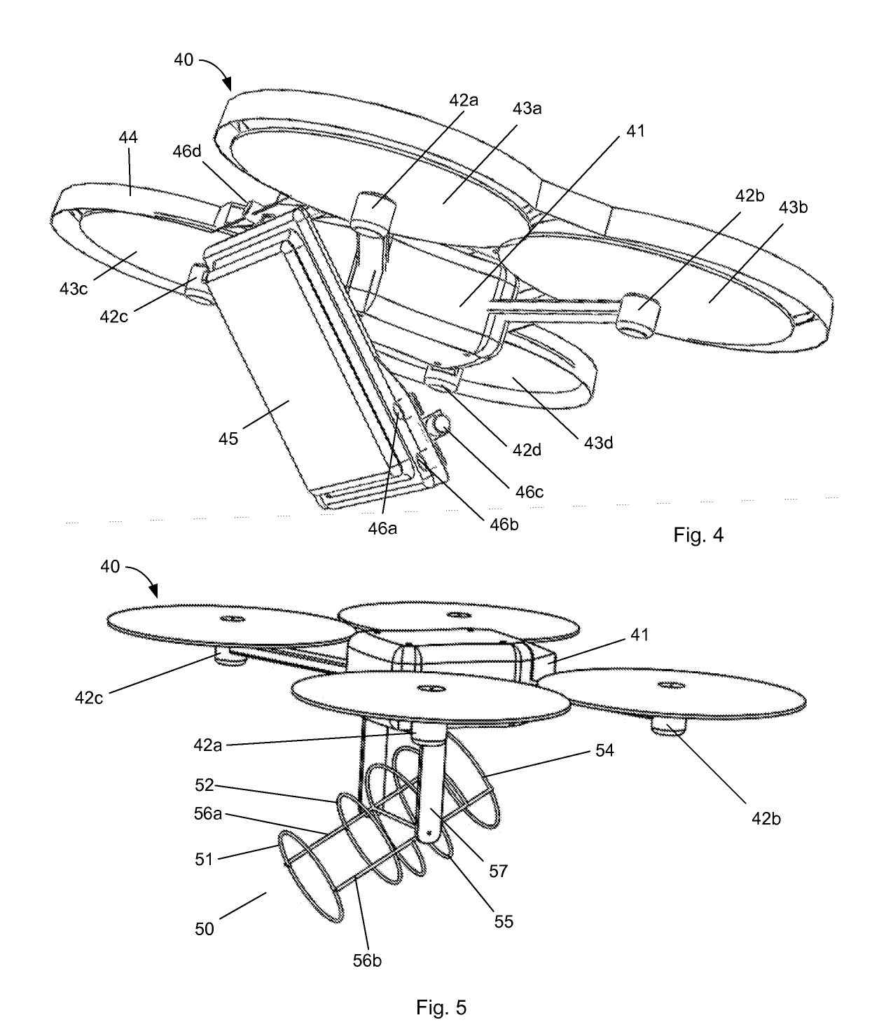

FIGS. 4-5 show two preferred embodiments for aerial robot 40 in oblique view. Aerial robot 40 is preferably fabricated from molded plastic parts for housing 41, arms, and propeller guard 44. Motors 42a-d turn propellers 43a-d (shown as a blur as if in rotation) to provide lift, and to control pitch, roll, and yaw. Commercially available quadcopters such as the Iris from 3D Robotics and the DJI Phantom 2 represent aerial platforms that are suitable for constructing aerial robot 40.

Aerial robot 40 is capable of movement in any direction and in preferred embodiments implements a scan pattern comprising vertical movements between vantage points.

Propeller wash from aerial platforms such as quadcopters offer a benefit of moving or fluffing scanned retail items whereby causing small movements at the attached RFID tag that have the potential of improving RFID tag read rates.

Planar patch antenna 45 preferably has sufficient gain to produce a strong forward lobe with a narrow beam width and much smaller side lobe strengths for both E and H electromagnetic fields.

Sonar transducers 46a-d are preferably used to for indoor navigation and to prevent collisions. Ultrasonic acoustic waves preferably bounce back to transducers 46a-d as each one emits an acoustic waveform and waits for an echo. The reflected responses are preferably timed in order to determine the range to the nearest object face that is capable of reflecting the incident waveform. Distance information is used to alert autopilot 64 of nearby obstacles and points of reference.

In a preferred embodiment sonar is used to detect faces and edges of such items using distance measurement and sudden changes in distance measurements to define edges within a coordinate system.

The primary purposes of the forward-looking sonars are to detect features that define aisle edges and to avoid collisions with obstacles and people. The primary purposes of the side-looking sonars are to conduct mapping operations and to verify the location of the robot within a store relative to an existing map.

Autopilot 64 preferably contains accelerometer 63a, gyroscope 63b, digital compass 63c, barometer 63e, and CPU 63d. The Pixhawk PX4 autopilot from Pixhawk.org is representative of this type of autopilot. It uses a 168 MHz/252 MIPS Cortex-M4F ARMv7E-M CPU with a floating-point unit. The PX4 also has 14 pulse width modulation (PWM) outputs to servo-control motors and control surfaces, including quad electronic speed control (ESC) 68a. In addition to serving navigation and control loop inputs, accelerometer 63a is preferably used to report the Z-axis angular attitude of aerial robot 40 and through a known offset angle, the vertical angular component of antenna 45 relative to the earth's gravitational field. The attitude of aerial robot 40 is preferably reported to data collector 66 using port 64a. Port 64a is preferably either a serial port (either synchronous or asynchronous) or a universal serial bus (USB).

Data collector 66 is preferably comprised of a 32-bit CPU 65a and 512M bytes of RAM 65c that are preferably combined into a single module such as the Broadcom BCM2835 700 MHz ARM1176JZFS. Clock 65d is used to time RFID data acquired from RFID interrogator 67a and aerial robot 40 attitude reports that are received over port 64a.

Memory 65c preferably holds records of each tag read and their corresponding timestamp. Aerial robot 40 flight position and attitude are also recorded with timestamps. FIG. 14 illustrates a preferred flight path over retail store sales floor 140 beginning at starting point 141 and flying along a linear row-by-row pattern collecting data into memory 65c. Preferred embodiments also run a pattern of rows along another heading in order to further enhance RFID tag location data sets recorded in memory 65c. FIG. 8 shows a second heading that is offset 90 degrees to the first. RFID tag and attitude data stored in memory 65c preferably has numerous vantage points that are processed to determine the Cartesian coordinates of retail items.

Vantage point computations preferably consider the downward angle of antenna 45 or 50 relative to the top plane of aerial robot 40 as shown in FIGS. 1 and 3. Except when hovering in one place, aerial robot 40 also has angular offsets in pitch, roll, and yaw that must be considered. The gain and resulting beam shape of antenna 45 or 50 also determines the amount of angular uncertainty for each RFID tag reading.

A plurality of RFID tags are preferably attached or embedded into retail items or their packaging and are represented by RFID tags 142a-x in FIG. 14. The tags are not arranged in any particular order or pattern as FIG. 14 may suggest. The tags are responsive to RFID interrogation signals from antenna 45, 50, 224, or 350.

Preferred antenna embodiments are low mass and have a small surface area that may deflect propeller air flows such as prop wash and propeller down drafts, whereby altering force vectors acting on the MAV. Preferred embodiments have antenna means attached to the platform for forming radio waves into a primary lobe that extends along an instantaneous vector from the platform.

FIG. 5 shows aerial robot 40 as a mobile platform carrying a preferred embodiment of the antenna means. It is a high gain circularly polarized four-element quadix antenna 50 adapted from a 146 MHz design by Ross Anderson W1HBQ. It uses mounting bracket 57 for aiming the primary lobe of the radiation pattern along an instantaneous vector from the platform. It has support members 56a-b that are preferably made of carbon-free plastic.

The present invention teaches means to remotely energize and collect identifiers from RFID tags that are attached to retail items and located along that vector. In a preferred embodiment, RFID interrogator 67a drives an RF signal through a balun into two-turn helical 55 of quadix 50. Reflector 54 is a parasitic element at the rear of antenna 50. Directors 51 and 52 are at the front of antenna 50. The overall gain is about 11 dBi which is the preferred minimum gain for remotely energizing RFID tags, propagating electromagnetic waves to them, and controlling them according to a protocol to backscatter their unique identifiers back to antenna 50 for RFID module 67a to receive, demodulate, and collect into data collector 66.

Quadix antenna 50 has advantages such as minimal weight and minimal wind interference; preferred embodiments use 12 AWG copper wire for the elements and in total weigh less than four ounces. With respect to an MAV, these are advantages over a high gain patch or panel antennae, a Yagi-Uda, or a conventional helix with the large reflector that it requires.

An advantage of quadix antenna 50 over planar antenna 45 is the minimal amount of obstruction that antenna 50 imposes on the downward airflow from propellers 43a-d. The antenna pitch angle is between 20 and 70 degrees below horizontal. The preferred angle is determined by aerial ground speed, RFID tag-scan rate, and location of tagged retail items relative to aerial robot 40. A more horizontal orientation favors shelf scanning and a more vertical orientation favors fly-over scanning. The mobile RFID tag-scanning platform has a pitch control loop that is stabilized by a microelectromechanical (MEMS) accelerometer 63a.

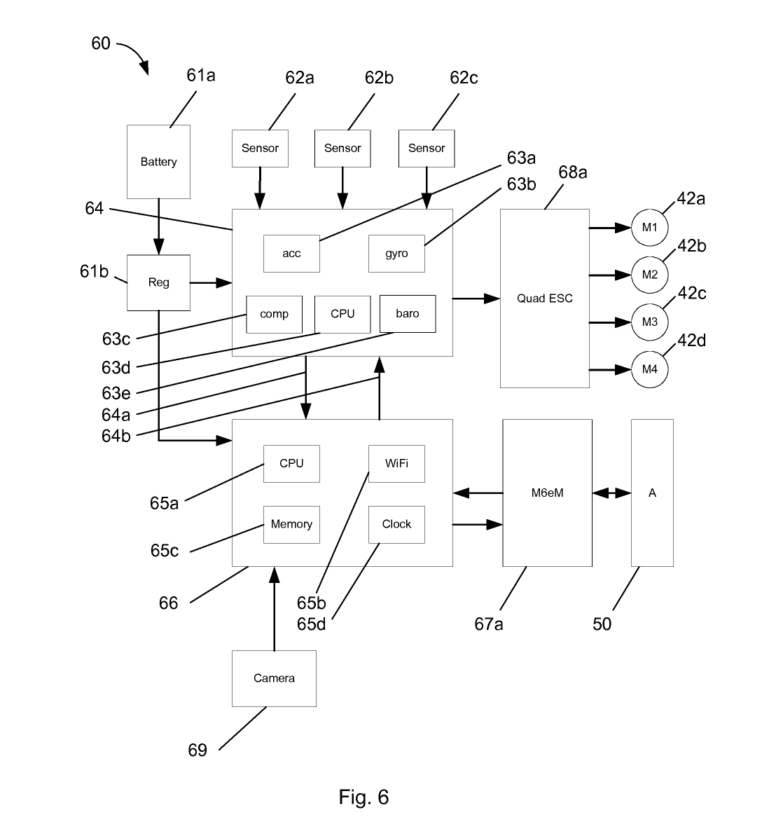

FIG. 6 shows a system block diagram 60 for the RFID tag-reading MAV, it is a preferred embodiment of control means to control the platform to instantaneous positions and an attached antenna 50 to point along instantaneous vectors to form a scan pattern relative to reference points using sensor data from the sensing means. The present invention teaches means to read RFID tag identifiers and store the identifiers with reference to the instantaneous positions and instantaneous vectors

In a preferred embodiment, autopilot 64 sends MAV platform position and attitude estimates to data collector 66 at a regular interval of 10 to 1000 times per second. The MAV platform position and attitude estimates are preferably time-stamped. The angle of antenna 45 or 50 relative to the MAV platform is preferably used as an offset from the MAV attitude readings from autopilot 64 and preferably recorded as an antenna position and attitude relative to the reference points or frame of reference. Data collector 66 also collects and records RFID tag reads from RFID Interrogator 67a that receives backscattered radio signals from antenna 50. RFID tag reads from RFID Interrogator 67a are also preferably time-stamped. In a preferred embodiment, as a post-processing step, the time-stamped position and attitude estimates are combined with the RFID tag read records to produce a record of spatial RFID tag readings.

Autopilot CPU 63d uses 3-axis accelerometer 63a, 3-axis gyroscope 63b, and digital compass 63c for indoor navigation and control loop inputs for three-dimensional translation and three degrees of rotation (pitch, roll, and yaw). The PX4 uses a ST Micro LSM303D MEMS accelerometer/magnetometer.

In other preferred embodiments, autopilot 64 and data collector 66 are combined into a single module.

Quad electronic speed control (ESC) 68a uses pulse width modulation to control speed of DC motors 42a-d.

Sensors 62a-62c preferably sense optical flow, barometric pressure, reflected laser light, ultrasonic reflections, and image processing outputs for indoor navigation.

In a preferred embodiment, a sensor 62a for example is a Lidar that emits laser light, preferably in the 600 to 1000 nm wavelength range. A laser diode is focused through a lens apparatus and directed using microelectromechanical systems (MEMS) mirrors for example. Preferred laser beam scan patterns include general forward-looking patterns, sweeping the area in front of the MAV, or patterns that sweep through broader angles including a full 360-degree field of view. Raster scan patterns sweep through yaw and azimuth angles. A Lidar receives and analyzes the reflections off of objects that surround MAV 40. Return light is amplified and processed to create a map or to determine the position of MAV 40 within an existing map for navigation.

Preferred embodiments of MAV 40 sense ground effect using accelerometer 63a, gyroscope 63b, or barometer 63e. Sensing incremental increase in lift or air pressure while landing or passing over objects such as retail displays and shelves. Barometer 63e such as MS5611-01BA03 from Measurement Specialties provide CPU 63d with altitude resolution as fine as 10 cm and is sensitive to an increase in air pressure due to propeller wash. Sensing ground effect when flying over retail displays helps to reinforce platform localization.

Regulator 61b provides regulated DC power from battery 61a for autopilot 64, ESC 68a, and data collector 66.

CPU 65a of data collector 66 preferably receives an asynchronous stream of RFID tag data from Interrogator 67a that in a preferred embodiment is a ThingMagic M6e-Micro, capable of sending data at a rate of up to 750 tag records per second. Tag read records preferably include Meta data such as RSSI and are preferably recorded in memory 65c, including duplicate tag identification numbers. This is unlike prior art RFID tag readers such as handheld RFID tag readers in that prior art typically use a hash table or similar means to deduplicate tag sightings so that only a single tag sighting is reported, sometimes also with a count of the number of times that it was seen by the reader. In the present invention CPU 65a uses time clock 65d to timestamp tag sightings before they are stored in memory 65c. In a preferred embodiment, CPU 65a and memory 65c are combined within a single device such as the Broadcom BCM2835.

RFID tags that are encoded with a geographic location are preferably located at positions in the retail store that can be observed by aerial robot 40. Marker tag 90 is a preferred embodiment that has a directional field pattern as described in patent WO 2009/037593. Parasitic elements including a reflector and one or more directors cause reflected radio waves to form a narrow beam. Such elements are reflector 91 and directors 95-97. Element 92 is attached to radio frequency identification circuit 93. In preferred embodiments, circuit 93 is also comprised of LED 94 which is either field-powered by the interrogator or by a battery attached to tag 90. LED 94 illuminates when transponder circuit 93 is energized by a remote RFID interrogator.

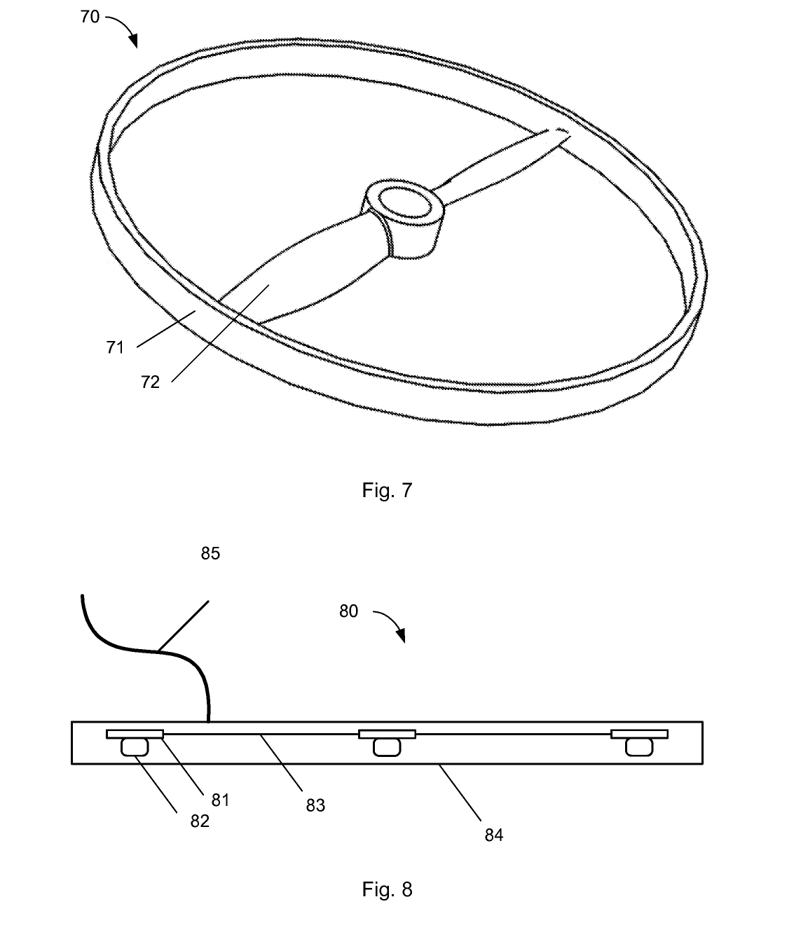

In preferred embodiments of aerial robot 40, camera 69 is mounted preferably with a forward view during flight. Images from camera 69 are preferably sensitive to light from LED 94 which is preferably modulated by RFID interrogator 67a at a rate that does not exceed half of the frame rate of camera 69. As location marker tag 90 receives interrogation signals from antenna 50 as aerial robot 40 flies toward it, camera 69 receives light and uses its position in the field of view of camera 69 to visually navigate to it. In other preferred embodiments, numerous light emitting tags 90 are arranged on retail floor 140 such that the spacing is known by aerial robot 40. A preferred embodiment is vectored arrangement 100 with directional RFID location tags 90a-f arranged as shown in FIG. 7. As robot 40 flies toward vectored arrangement 100 the apparent distance between LEDs 94a-f increases in the field of view of camera 69 by an amount that is proportional to the distance from robot 40 to vectored arrangement 100. In one embodiment, identification of which tag 90a-f is which is controlled through modulation of tags 90a-f in a manner that visually distinguishes LEDs 94a-f from each other.

Vectored arrangement 100 is comprised of directional tags 90a-f each having RF field patterns with central lobes of maximum responsiveness along vectors that are spaced at regular intervals such as every 30 degrees. In preferred embodiments adjacent field patterns overlap each other such that more than one tag 90a-f responds to interrogation signals from antenna 45 or 20. Vectored location arrangement 100 of narrow beam transponders 90a-f are responsive to RFID interrogation signals, and comprising geographic encoding that uniquely identifies the arrangement and coding that identifies the angular offset of each individual transponder 90a-f from a reference angle.

Preferred signal processing in data collector 66 uses received signal strength indication (RSSI) for each response from directional tags 90a-f as reported by RFID interrogator 67a. Since each location tag 90a-f is constructed and mounted under controlled conditions, the RSSI readings accurately represent the combined affects of range and off-axis signal losses.

Autopilot 64 preferably uses geographic tag 90 sightings as indoor navigation inputs that are communicated to it over port 64b. Course correction from location marker tags enables aerial robot 40 to maintain a true heading relative to a flight plan such as the flight plan that begins at starting point 141 shown in FIG. 14.

Post processing steps preferably combine same tag sightings from various positions and attitudes as reported by autopilot 64. The sightings are preferably used to construct spatial representations that use the vector that is normal to the antenna face or primary axis as a known vector related to the sighting. Depending upon antenna gain, the actual vector from the antenna to the actual tag location can, and most often does deviate from that ideal normal time-dependent candidate vector. A plurality of candidate vectors are processed through an algorithm that determines all possible combinations of candidate vectors that would account for the aggregated tag sightings. Those resulting vectors are then processed through an algorithm whereby the Cartesian coordinates of the RFID tag are computed.

Each tag record in memory 65c preferably contains these identifier fields: Timestamp, SGTIN identifier, RSSI, and reported aerial robot 40 position and attitude data (X, Y, Z, pitch, roll, yaw), comprising time-synchronized collected identifier data and stored estimates of platform position and attitude. WiFi 65b is a preferred means to transmit the stored identifiers to a remote server that relates the identifiers to a shopper's web searches as disclosed below.

Multipath fading due to reflections, scattering and diffraction are generally suppressed by using high-gain antennas with a highly-focused radio beam. The reason for the narrow beam width is to improve localization, whereby off-axis tag to reader alignments are non-responsive to the reader's interrogation signals and reflective multipath signals are greatly attenuated.

Hence, steering of the beam by aerial robot 40 is necessary to cover the area to detect RFID tags 142a-x and location marker tags 90 and tag arrangement 100.

Propeller 70 has a continuous outer perimeter 71 so that hitting objects does not result in damage to the object, propeller blade 52, or MAV 40.

In other preferred embodiments, antenna 70 is also an antenna or part of antenna. For example outer perimeter 71 is preferably comprised of metal or selective metal plating used as a reflector or director similar to parasitic elements 51, 52, or 54 of antenna 50. In the case of a quadcopter, a 4-antenna 70 quad array has a high gain and the opportunity for electronic beam steering.

Other preferred embodiments of propellers incorporate blade profiles that create less turbulence than a conventional 2-blade propeller. The result is quieter operation, which is a benefit for scanning retail stores.

Aerial robot 40 preferably discovers and recalls the locations of features and fixtures of retail stores and warehouses in which it operates. Aerial robot 40 preferably detects shelves, racks, aisles, and furniture using sensors including RFID, sonar, and imaging devices.

The figures and descriptions for robots 10, 224, 350, and 40 teach novel solutions to the problem of providing cost effective means for accurately reading inventory counts and locations, even during the hours of regular business operations.

### Indoor Navigation

The robotic scanning platforms and the antennae attached to them as described above, whether the platforms be rolling, tethers, suspended from a ceiling, or flying through the air need to determine their location relative to reference points. The present invention teaches platform sensing means to sense remote reference points and locating means for determining the position of the antenna relative to the remotely positioned reference points. The sensing of reference points preferably uses electromagnetic waves in various parts of the electromagnetic spectrum from radio to visible light. Reference points include orbiting references such as GPS satellites and references that are at or near the surface of the earth such as cell phone towers, WiFi Access points, RFID transponders, and optical references. Skyhook is a company that uses remote external references including GPS, cell phone towers and WiFi access points to localize mobile devices.

Lidar is a preferred indoor navigation sensing means that uses sensor 62a as described above. It uses surrounding objects as points of physical reference within a stored map. Indoor navigation using Lidar is a line of sight sensing method.

The RFID reader is used in certain preferred embodiments as a preferred indoor navigation sensing means to read RFID transponders that mark physical locations in the operating environment. Transponders marking physical location are preferably rugged and operate well even if embedded in a concrete floor. UHF, HF, and LF transponders are all candidates; however the lower frequency transponders are generally better suited as floor location markers.

Location tags are RFID tags that are encoded with data that is different than SGTIN encodings that are used for item identification. The GS1 key type SGLN is representative of one type of location marking coding that is used in preferred embodiments for marking a physical location. In a preferred embodiment each SGLN encoded RFID tag would have a 28-bit field that is recorded in the UII memory bank of the tag within the GLN Extension field of the SGLN. The SGLN Company Prefix and Location Reference are preferably encoded according to GS1 standards of use. That GLN Extension field is preferably defined to have a 6-bit SubType field value to indicate the type of location that is marked. There are also preferably 11 bits for X location, 11 bits for Y location. For facilities requiring more numbering space, the GLN Location Reference is preferably used to indicate different sections of the facility. The present map is preferably responsive only to the Extension values within the section of the facility that they apply to.

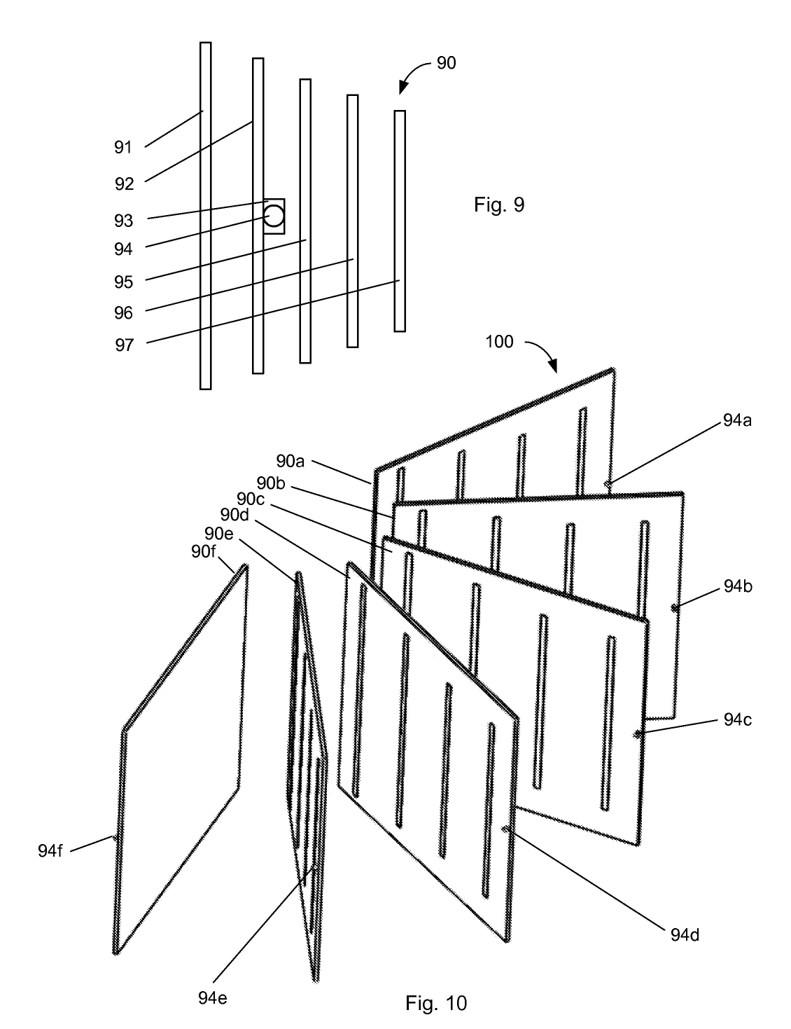

Prior art attempts to navigate using UHF RFID transponders to identify location references fail due to reflections and multipath problems that are well known to those skilled in the art. The present invention uses directional gain antennae to overcome that problem. FIGS. 9-10 are preferred embodiments for location-identifying transponders that only respond to RFID interrogation signals that are within the high gain central part of their field patterns. RFID interrogators that are located sufficiently off of the tag's central axis will either not power up the transponder or not receive the backscattered signal, or both. In preferred embodiments, the RFID interrogator also has directional gain to further reduce off-axis transponder excitation or receiving of multipath signals that have bounced off of surfaces within the store to return to the RFID reader at a wide off-axis angle relative to the reader antenna's central lobe.

Transponder 90 is a preferred embodiment for location-identifying transponders that are attached to drop ceilings or other overhead structures. They are preferably read by upward-pointed RFID antennae that read the transponders as they come into view over the RFID reader, the reader being attached to a mobile platform such as a rolling or flying robot. In such embodiments the upward-pointed antenna is a second antenna that is connected to a second antenna port of RFID interrogator 67a.

Another preferred indoor navigation sensing means uses points of reference such as radio beacons such as DASH7 (ISO18000-7 433 MHz) or extensions of Bluetooth 4.0 nodes and Wi-Fi access points, RFID transponders such as UHF or NFC tags, optical references such as barcodes, LEDs, lamps, light fixtures, or overhead optical location reference strips 80.

Optics provide another preferred indoor navigation sensing means by using calculations like nautical navigation by the stars is preferably used with camera 69 for determining the location of a mobile platform relative to the location references. Optical location references 80 are preferably within camera 69's field of view and are used like stars, the location references of which are received through the optical modulation.

The location references further comprise locations within a constellation map that is communicated to the mobile device. In a preferred embodiment, the three dimensional location of each location reference are compiled to create a constellation map. The constellation map is preferably communicated to each mobile platform through Wi-Fi such as Wi-Fi 65b of FIG. 6. In a preferred embodiment, the constellation map of location references is transmitted using either TCP or UDP packets. Using UDP packet, the constellation maps are broadcast such that each mobile device in the vicinity can use an internal dictionary or database to lookup the location of each location reference by its designator number.

In another preferred embodiment, source 80 modulates in synchronization with other sources 80. A preferred system synchronization reference is provided using a Wi-Fi message such as a UDP broadcast at each synchronization point. For example once every second, preferably with compensation for timing delays through the Wi-Fi stacks. Having that information available to each point that is observing light color and or pulses at various times helps to determine which source 80 is being observed with a camera's field of view as is described in further detail below.

In other preferred embodiments, sources 80 are replaced with moving parts that direct a beam or a strip of light in a preferred manner. In certain preferred embodiments, the light source is s laser that is moved using micro-machines and small mirrors in a controller manner.

In another preferred embodiment, conventional fluorescent tubes are replaced with LED arrays with optical location references built in. LED arrays are commercially available in standard sizes and lengths and do not require a ballast. In the preferred embodiment, a segment of the white LEDs is modulated from time to time at a rate that is slower than the frame rate of camera 69, preferably at about 12 Hz. By using various colors and patterns, coding schemes are possible to encode data such as a different identifier for each LED array. Using data and synchronization pulses sent through the power feeds, the LED tubes can be controlled and updated. By using sufficiently large device numbers, LED tubes can be numbered when manufactured.

Uniquely identified LED tubes offer the dual benefit of more efficient lighting than fluorescent tubes and the opportunity for indoor navigation for smart phones, tablets, and other mobile devices. Camera 69 preferably resolves the LEDs that are switched on or off and using graphics processing in CPU 65a, calculates relative distances between LEDs that are on or off. The distance to the optical location references are computed using the pixel distance between parts of the optical location reference pattern. The parts of the optical location reference pattern are further comprised of two outer symbols that maintain a known number of LED spaces between them as a spatial reference.

Using accelerometers in each of three planes, the pointing angle of camera 69 is computed for the mobile device enabling navigations using the encoded sections of each LED tube as a known point in space to reference from. Using at least three such points enables robot 10 or 40 to accurately compute its in-store location.

Camera 69 is preferably used with tracking the centroid of optical references, optical flow, and vanishing point navigation to recognize and guide a path for robots or shoppers through aisles. Optical flow is the pattern of apparent motion of objects, surfaces, and edges in a retail store caused by the motion of a camera 69 on a mobile platform. Vanishing point navigation uses the parallel lines of store aisle, shelves, windows, and overhead lighting rails to compute a distant target, such as the end of an aisle; it also provides visual angular alignment for squaring the robot for accurate triangulations and transponder location measurements.

Beams and optical patterns of various types are dispersed through the surrounding space in order to provide an optical point of reference. In some embodiments dispersion is achieved using motion, moving mirrors, and/or other optical elements. In other embodiments, dispersion is achieved using fixed optical elements. In a preferred embodiment color is used to encode angular position relative to a reference angle in any combination of X, Y, or Z planes. A prism or diffraction grating is used in one embodiment to diffract a white light source such as a white LED into red, orange, yellow, green, blue, indigo, and violet. Cameras in mobile platforms preferably use the color-encoded information to locate themselves relative to an optical reference.

FIG. 8 is a drawing of overhead optical location reference strip 80 comprising a linear array of LED 82 mounted to modulation device 81, connected by wiring 83, and contained with structure 84. Cable 85 preferably provides power and control. Each modulator device 81 preferably flashes its corresponding LED 82 in a manner that enables cameras on mobile platforms to compare from frame to frame the changes in intensity such that information is decoded. The information is preferably a reference number to that LED 82 or coded location coordinates within a constellation map. Various modulation depths and binary or multi-level intensity encoding is used in certain preferred embodiments to transmit the data.

Acoustic sensing is another preferred indoor navigation sensing means using ultrasonic sonar modules as disclosed herein. Sonars also provide collision avoidance means to avoid collisions with obstacles. Sonars 46a-d emit an acoustic pulse and measure the echo magnitudes and delay times to determine the distance to nearby objects. For a sonar module such as the MaxBotix MB-1000 sonar the minimum detectable range is about 6 inches. Using the timing pulse width output PW and the conversion factor of 147 us per inch the range measurement is determined. Sonar modules preferably report range to objects that reflect acoustic waves and enable robot 10 or 40 to stop or to take evasive action. Escape maneuvers of robots 10 or 40 preferably include reversing, pivoting, and changing direction to go around obstacles such as walls, furniture, people, and movable objects.

Robot 10 preferably constructs a retail store map that is responsive to changes in locations of physical objects within the retail store. The map is preferably stored in a local memory device such as RAM or Flash. Data is preferably organized for fast retrieval based on the position of interest with a retail store or warehouse. In a preferred embodiment Winbond W25Q128FV serial Flash memory devices are used, affording robot 10 128M-bits of local non-volatile map storage for each device. This results in 2²⁴ bytes of randomly addressable space, the preferred organization of which is disclosed below.

A preferred use case for robot 10 is to escort it to a point of reference such as the intersection of two major aisles in a retail store. Robot 10 is then preferably activated to learn the locations of the store features without any further human guidance or interaction. Robot 10 also preferably adapts to changes in the locations of objects within the store without human intervention.

In a preferred embodiment, the initial reference location is defined in X,Y,Z Cartesian coordinates as 0,0,0 where the XY plane is coincident with the sales floor that robot 10 navigates upon. The Z dimension is preferably height above the floor with positive values for positions above the floor.

A four-byte (32-bit) record is preferably used for each cell of a map that is organized as an XY array of cells that map onto the retail sales floor. Preferably X defines distance parallel with the storefront and Y defines distances perpendicular to the storefront. The 0,0,0 location may be in the center of the store with positive and negative X and Y values extending along the four major vectors therefrom. Each cell is preferably addressed by using a concatenation or other combination of the X and Y values of the mapped location within the retail store.

A 128M-bit memory device has 24 bits of addressable bytes. Using a four-byte record there are 24 minus 2 or 22 bits used to address each record. Splitting those 22 bits equally into X and Y numbering space would provide 11 bits for X and 11 bits for Y cell addresses. This provides 2048×2048 spatial resolution in the XY plane. Using a scale factor of 6″ for each X and Y increment, a 1024′×1024′ space is readily mapped. This corresponds to over a million square feet of retail space for each robot to operate within.

FIG. 15 is a diagrammatic representation of a map superimposed onto a top view of a sales floor in an example of a preferred embodiment. Storage rack 151 is shown in the upper right corner of the portion of the map. Each cell is shown as a square such as LT1 cell 153.

LT1 Cell 153 contains a reference record that points to an SGLN location tag that is located 90 degrees to the right, which in this case refers to location tag 152. The X and Y coordinates within the tag are copied into the reference record. The type of tag is read from the tag and mapped into a SubType field.

SC1 cell 154a and SC2 154b each contain a record with a pair of sonar range readings and a digital compass reading. The sonar readings to the right indicate a range from the cell 154a or 154b to storage rack 151.

SE1 cell 155a and SE2 cell 155b both contain records that indicate a sonar Rmin reading and an Edge location measurement to provide robot 10 with two views of the nearby edge of storage rack 151.

OB1 cell 156 is an object boundary reference cell, record Type 10 SubType 000001 with a value to indicate a zero distance to the leftmost boundary relative to the center of the cell.

SO1 cell 157 is a record Type 10 SubType 000000 record to indicate a region that lies completely within a solid object.

The map therefore preferably contains both sonar readings to objects and vectors at specified angles to reference location tags. The combination of the two provides a robust mapping system that uses fixed reference points (i.e. location tags) and moveable objects that contain goods or must be navigated around in order to avoid collisions.

Each record in the map as represented in FIG. 15 is randomly addressable which enables fast lookup of a location of interest and the surrounding areas of interest. In a first step robot 10 preferably creates an estimate of its current location and converts that estimated location into a central map memory address for a cell. The central address is used to compute the memory addresses of the 24 cells around that central cell, including each of the 8 near perimeter cells and each of the 16 cells that surround those 8 near perimeter cells. An example of that region of interest is shown as map region 158 that surrounds SE2 155b in FIG. 15. Cells data is read and interpreted including sonar ranges to nearby objects and feature edges, location reference tag sightings, and object boundary or solid object references. An aggregation step is to use cell records to construct a local map of the features that are in and around region 158.

Odometric estimates are derived from controlled rotation of wheels 14a and 14b that are measured to track the movement of robot 10 from cell to cell resulting in grid-crossings. Correlation between physical movement and calculated changes in position maintain a tight correspondence between the logical map and the robot's actual position on the floor. It is critical that the diameter and the circumference of the wheels 14a,b are known so that rotatory motion can be accurately converted into computed linear odometric displacement. Velocity differences between wheel 14a and 14b will result in robot 10 changing direction. Maintaining a straight course requires that both wheels 14a,b rotate at exactly the same velocity.

MAV 40 using lidar, sonar, or sensing of RFID location marker tags for indoor navigation means is able to navigate and operate in a dark room. This is an advantage for scanning retail stores after hours when shoppers are not present.

### Cross-Channel Product Search

The present invention uses data from a plurality of RFID tags having unique item identifiers, found and located in retail stores, and preferably stores that data in searchable database. This invention also includes product search means for a web-based product search that include searches into that database. It further includes means for relating the unique item identifiers from the plurality of RFID tags to the web-based product search. This entails relating means for relating at least one of the scanned items' identifiers to an item of interest. Preferred embodiments further comprise means for the shopper to express readiness to purchase using a “BUY” button or icon.

Omni-channel retail systems, methods, and devices are disclosed in the present invention that are both responsive to a consumer's present focus of retail product interest and to availability of relevant inventory.

Key cross-channel product search aspects of the present invention are:
1) determining the consumer's present focus of product interest using opportunistic media content (i.e. media content from a variety of sources that captures a consumer's interest),
2) accurately determining the availability of relevant product by scanning from one or more vantage points, and
3) determining product purchase recommendations using the triple constraint triangle.

The present invention discloses a retail sales channel that is triggered by simple cues by the consumer while using any of several devices that advance the consumer's interest in specific products, including devices such as: desktop, laptop, tablet, smartphone, set top box, flat screen television or monitor, and home or car radios.

Determining what is relevant is achieved using systems, methods, devices, and software applications that include: bookmarklets for web browsers and media identification services such as Shazam and SoundHound for identification of media that a consumer is currently engaged with including songs, television shows, TV commercials, and radio commercials.

In a preferred WR2.0 method and system, a consumer uses a smartphone to capture a photo of an object of interest such as a shoe, a handbag, a car, a hat, or a home, for example and uses that as input to a recommendation engine as described below. Preferred embodiments use image recognition application software or an image recognizer to identify objects of interest, as expressed in the captured photo. Examples of image recognition application software include MATLAB, Google Goggles, and Google Image Search.

Content-based image retrieval (CBIR), or query by image content (QBIC), and content-based visual information retrieval (CBVIR) are preferably used to compare images of interest to a database. Preferred embodiments of database are contained in second server 165. Examples of prior art CBIR implementations are iPhone Apps like Pounce from BuyCode Inc., SnapTell (acquired by Amazon), Amazon Mobile, and Snooth Wine Pro by Snooth.

Technological challenges for image recognition, CBIR, QBIC, and CBVIR leave performance gaps at the present state of the art which may be overcome as algorithms improve and image capture and image processing hardware improves. In the interim, preferred embodiments of the present invention use annotation to compliment the object identification process, enabling it to resolve to a single, correctly identified object. In a preferred embodiment of the present invention, text descriptions are used to provide the annotation. The text is either typed or spoken into a voice-to-text converter such as the Apple iPhone's Siri.

In preferred embodiments, annotation is used to clarify what object in an image is the object of intention where there may be multiple objects in the image. For example, a woman may snap an image of a shoe that is one of a pair of shoes that someone else is wearing. In a preferred embodiment, she captures an image using any of various zoom and magnification options to compensate for distance, surrounding lighting, or other optical factors. The object recognition engine of the present invention preferably parses her typed or spoken annotation “shoe”.

Preferred embodiments of systems and methods that use image recognition enable consumers to admire an object and ask their smartphone, instead of a person, such as the owner of the object, the familiar question “where did you get that?” or “where can I buy that?”.

In a preferred embodiment, a three-dimensional representation of the desired, observed, and photographed object is used to capture, sort, recognize, index, store, and retrieve items of interest. In preferred embodiments, 3D objects are represented in machine memories as 3D virtual objects. 2D images are preferably derived from the 3D virtual object in cases where a 2D display is used for human visual perception.

A preferred class of camera is a light field camera, also referred to as a plenoptic camera. This type of camera uses a microlens array to capture a 4D light field. Pelican Imaging is a company that uses a 16-lens array camera that is targeted for use on smartphones. In a preferred embodiment a consumer uses a smartphone with a plenoptic camera to capture a plenoptic image that is processed and used to generate search vectors.

Determining relevance further comprises the step of a recommendation engine that is predisposed to filter available inventory options using the consumer's expressed preferences for quality, price, and delivery speed.

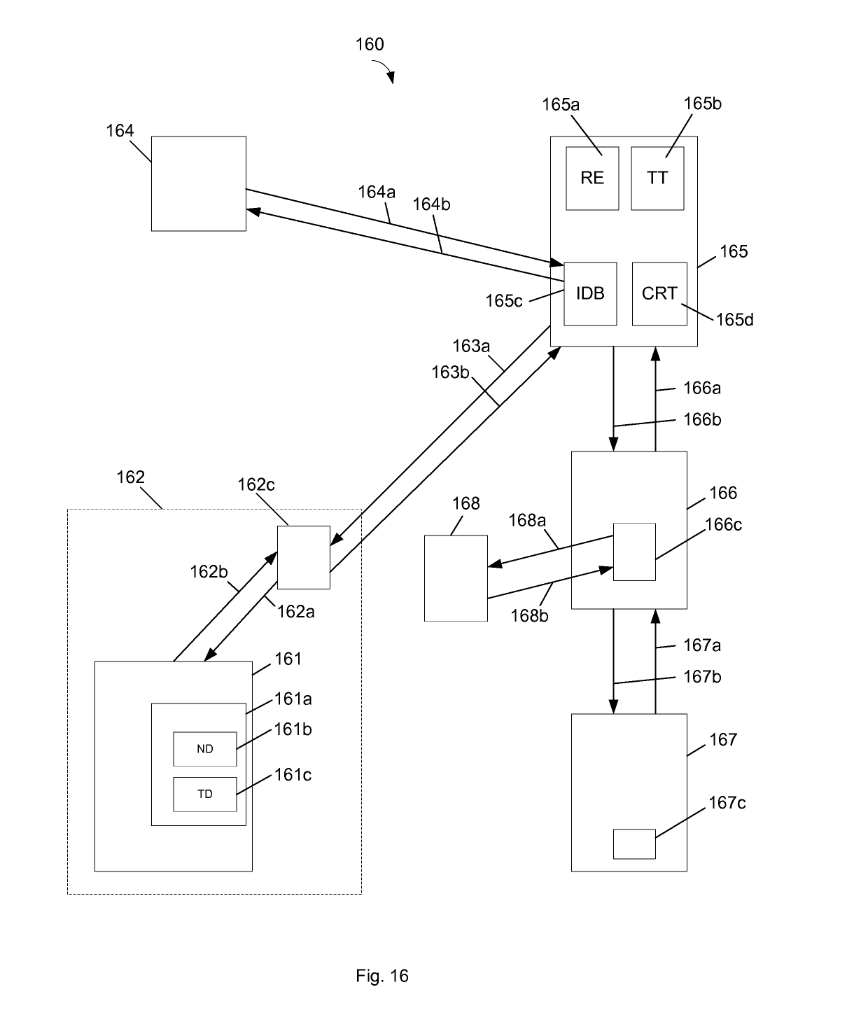

Referring now to FIG. 16 is an omnichannel system for recommending and selling goods to a consumer based on what products the consumer has been exposed to through various advertising and information delivery channels. The source of the advertising and information is media content from a first server (not shown in FIG. 16) and is served in any number of traditional ways.

Inventory information from inventory scanning system 164 is preferably downloaded to second server 165 through communications channel downlink 164a and confirmed through uplink 164b. In a preferred embodiment inventory-scanning system 164 is comprised of one or more robots 10 or 40 that scan from a constellation of vantage points.

The inventory information is preferably stored in the second product database namely item database IDB 165c that is a database of SGTIN-coded retail items with X, Y, and Z coordinates that are representative of their in-store location. IDB 165c preferably uses SQL or non-SQL database architectures that are adapted for the uses described herein. In a preferred embodiment, IDB 165c also includes records of gently used items that are for sale. In a preferred embodiment data is stored in a table with GTIN as the primary key, a total count of that GTIN stocking level in all locations, and fields that specify retail store locations by their GPS longitude and latitude. Each record of that table links to a table with fields: SGTIN, and in-store location parameters: floor, X, Y, and Z.

Referring now to retail system 160 in FIG. 16, media content presentation devices such as computer 162 and audio/visual device 167 are preferably any of several devices that advance the consumer's interest in specific products, including devices such as: desktop, laptop, tablet, smartphone, set top box, flat screen television or monitor, and home or car radios. Such devices are preferred origins of purchasing cues for affecting the consumer's present focus of product interest using opportunistic media content as described below.

Audio/visual device 167 is preferably a television, flat screen TV, or a radio with signal receivers for AM, FM, and/or satellite broadcast signals. Computer 162 receives targeted content 161a over a packet-based network such as TCP/IP from first server with a first database, whereas TV/radio device 167 receives content 167c from a wireless broadcast signal.

Media content 161a is a web page served by a first server and displayed and controlled through a graphical user interface that includes web browser 161. Content 161a preferably contains HTML-formatted content including text and images with numerical descriptors ND 161b and text descriptors TD 161c relating to the first database.

Media content 167c is preferably comprised of audio and/or video information that is primary presented in human-understandable forms.

Media content 161a and 167c from time to time will elevate the consumer's interest in a product to the point of becoming interested in price, delivery, near alternatives, and product pedigree. This moment is a purchase interest cue that is defined by a definitive action on the part of the consumer.

A purchase interest cue occurs in web browser 161 when the consumer invokes bookmarklet 162c preferably to activate JavaScript code; this is preferably done with a click on the bookmarklet's icon on the bookmark bar of browser 161 in computer 162.

A purchase interest cue occurs for media content 167c when the consumer clicks to activate smartphone app 166c in smartphone 166. Smartphone app 166c is preferably a media content identification app such as Shazam or SoundHound and is preferably communicative with server 168 over Internet downlink 168a and uplink 168b. Smartphone app 166c preferably uses consumer-activated uplink 166a and downlink 166b to notify second server 165 of the purchase interest cue and initiates a translation, if necessary, by translation table TT 165b to clearly identify the consumer's interest in a product.

In another preferred embodiment, consumer interest identification for clicks and other browsing activity within web browser 161 is directly coded into web page 161a with a link back to the first server. For embodiments of that type, bookmarklet 162c is not necessary and in FIG. 16 functional block 162c merely passes downlink 163a to 162a and uplink 162b to 163b to second server 165. Consumer interest is signaled directly to second server 165 through HTML coding where text and images are coupled with specific product offerings.

In the present invention a system for performing consumer interest identification related to media content 161a is performed by bookmarklet 162c to collect ND 161b and TD 161c elements and sending them to second server 165 that is a different server than the host server that media content web page 161a receives its web pages from. Internet downlink 163a and uplink 163b to second server 165 are parts of a separate channel to provide supplementary shopping information that enables Webrooming 2.0 (WR2.0) functionality.

The present invention teaches interest expression means for a shopper using the GUI to express interest in an item to a recommendation engine. At the moment when the consumer engages with the cue expressing interest, the system goes to work mining data relevant to the shopper's expressed interest by collecting data from the region of interest on the current web page being viewed by the shopper, extracting at least one product identifier including HTML, numerical descriptors ND 161b, preferably a GTIN, and text descriptors TD 161c. The relevant data mined and found preferably includes recent and accurate WR2.0 inventory data using automated scanning methods such as those described above.

WR2.0 shopping determines what is interesting to the consumer at a critical moment in time is achieved using systems, methods, devices, and software applications that include: bookmarklets for web browsers and media identification services such as Shazam and SoundHound for identification of media that a consumer is currently engaged with including songs, television shows, TV commercials, and radio commercials.

Determining relevance based on that interest comprises the step of recommendation engine RE 165a that is predisposed to determine product purchase recommendations using the triple constraint triangle of interrelated consumer preferences for quality, price, and delivery speed. These consumer preferences are stored in customer records table CRT 165d. The present invention teaches ranking means for ranking the related items using relational criteria, a preferred relational criteria is the triple constraint triangle for quality, price, and delivery speed.

Preferred indicating means for indicating the top ranked items to the shopper include an embodiment wherein products are displayed to a shopper in their browser, using information from second server 165. Browser page 161a preferably has one or more of numerical descriptors ND 161b or textual descriptors TD 161c in an HTML file that is being read by a browser such as Internet Explorer, Safari, Mozilla, or Chrome. Although HTML is preferred, other standard generalized markup languages are used in other preferred embodiments.

Numerical descriptors ND 161b that are embedded into some web pages refer to a proprietary numbering system. An example of such a system is Amazon.com using the proprietary ASIN (Amazon Standard Identification Number). Preferred embodiments of the present invention use translation table TT 165b to convert proprietary ND 161b descriptors into standard GTIN's.

Preferred embodiments provide means for the owners of each GTIN to provide cross-referencing ND 161b and TD 161c information for each GTIN that they own and wish to sell associated products through the presently disclosed system.

The consumer preferably activates Bookmarklet 162c to read ND 161b and TD 161c information and send it to second server 165.

Second server 165 preferably decodes ND 161b and TD 161c to determine what the consumer is interested in purchasing and preferably reducing that to a GTIN.

SGTIN data from robot 10 or 40 and others like it in retail stores preferably send through Wi-Fi 65b inventory data to a server where it is preferably stored and organized as searchable SGTIN records in IDB 165c.

Recommendation engine RE 165a is preferably a hybrid recommender information filtering system. RE 165a preferably utilizes content-based filtering and collaborative filtering. Content-based filtering preferably associates similar items, making recommendations based on the consumer's expressed preferences stored in CRT 165d. Collaborative filtering is preferably used for making recommendations regarding more subjective differences between products and brands including consumers' aggregate perceived differences in quality of various recommendation options.

RE 165a preferably collects implicit data including: items viewed by the consumer in web pages served by an online store, time spent viewing them, purchases previously made, and social network “like and dislike” history. RE 165a also preferably compares the collected data to similar data collected from other consumers.

Recommendation engine RE 165a preferably uses inputs like those described above and some or all of these additional inputs to provide a ranked presentation of retail goods for sale: consumer's stored CRT 165d preferences for quality, price, and delivery speed, and product availability, distance and transportation costs, and probability of return.

Recommendation engine RE 165a uses a consumer's stored CRT 165d preferences to rank product purchase options through evaluation of the price, condition, and physical locations of the SGTIN-coded retail items for sale, and preferably compares those attributes to the offering in the media content. The condition of the SGTIN-coded retail goods for sale may be coded as a returned item or as being previously owned.

While the invention has been particularly shown and described with reference to certain embodiments, it will be understood by those skilled in the art that various changes in form and detail may be made without departing from the spirit and scope of the invention.

I claim:

1) An inventory locating system comprising:
a plurality of RFID tags attached to retail items;
a high gain antenna attached to a platform;
means for the RFID tags to respond to a radio frequency interrogation signal from the antenna;
positioning means for autonomous positioning of the antenna in a scan pattern;
platform locating means for determining the position of the antenna relative to remotely positioned reference points;
tag locating means for determining the location of the RFID tags relative to the reference points;
reading means for reading a unique item identifier from each of the plurality of RFID tags;
product search means for a web-based product search;
and means for relating the unique item identifiers from the plurality of RFID tags to the web-based product search.

2) The autonomous positioning of claim 1 further comprising platform velocities in excess of 6 feet per second.

3) The scan pattern of claim 1 further comprising a sequence of vantage points along a line.

4) The scan pattern of claim 1 further comprising a sequence of vantage points along an arc.

5) The scan pattern of claim 1 further comprising vertical movements between vantage points.

6) The web-based product search of claim 1 further comprising the use of a graphical user interface.

7) A mobile RFID tag-scanning platform comprised of:
sensing means to sense remote reference points;
control means to control the platform to instantaneous positions to form a scan pattern using data from the sensing means;
collision avoidance means to avoid collisions with obstacles;
antenna means attached to the platform for forming radio waves into a primary lobe that extends along an instantaneous vector from the platform;
means to remotely energize and collect identifiers from RFID tags that are attached to retail items and located along the vector;
means to store the identifiers with reference to the instantaneous positions and instantaneous vectors;
means to transmit the stored identifiers to a remote server that relates the identifiers to a shopper's web searches.

8) The RFID tag-scanning platform of claim 7 further comprising controlled movement of the platform at a rate of speed greater than 6 feet per second.

9) The RFID tag-scanning platform of claim 7 further comprising a map.

10) The RFID tag-scanning platform of claim 7 further comprising operation in a dark room.

11) The RFID tag-scanning platform of claim 7 further comprising means to sense ground effect during flight over retail displays.

12) The antenna means of claim 7 further comprising more than one antenna.

13) The antenna means of claim 7 further comprising a weight of less than four ounces.

14) The reference to identifiers of claim 7 further comprising time-synchronized collected identifier data and stored estimates of platform position and attitude.

15) The mobile RFID tag-scanning platform of claim 7 further comprising a pitch control loop that is stabilized by a microelectromechanical (MEMS) accelerometer.

16) A system for finding desired retail items comprising:
a graphical user interface (GUI) for shopping for the retail items;
interest expression means for a shopper using the GUI to express interest in an item to a recommendation engine;
the items having at least one product identifier;
scanning means for automatically scanning retail store inventories for the presence and location of RFID tags;
relating means for relating at least one of the scanned items' identifiers to an item of interest;
ranking means for ranking the related items using relational criteria;
indicating means for indicating the top ranked items to the shopper.

17) The interest expression means of claim 16 further comprising means for collecting HTML that describes an item.

18) The system of claim 16 further comprising means for the shopper to express readiness to purchase.

19) The ranking means of claim 16 further comprising means for comparing price, delivery speed, and quality.

20) The location of RFID tags of claim 16 further comprising Cartesian coordinates.
